(19) United States
(12) Patent Application Publication
(10) Pub. No.: US 2026/0003327 A1
(43) Pub. Date: Jan. 1, 2026

(54) COMMON CONFIGURATION VALIDATION IN INDUSTRIAL DESIGN APPLICATIONS USING GENERATIVE ARTIFICIAL INTELLIGENCE

(71) Applicant: Rockwell Automation Technologies, Inc., Mayfield Heights, OH (US)

(72) Inventors: Brian C. Frank, Cedarburg, WI (US); Gerald W. Renderman, West Bend, WI (US); John P. Mason, Sussex, WI (US); Matthew S. Hill, Kitchener (CA); Chao G. Moua, Mequon, WI (US)

(21) Appl. No.: 18/754,682

(22) Filed: Jun. 26, 2024

(51) Int. Cl. G05B 13/02; G05B 19/4097

(52) U.S. Cl. CPC G05B 13/0265; G05B 19/4097; G05B 2219/35066

(57) ABSTRACT

The present disclosure describes systems and methods for reviewing user selections in an industrial design application. Embodiments include leveraging a Generative Artificial Intelligence (GAI) model to review the selections. The GAI model is trained to recognize common selections of configuration options among users of the industrial design application. The disclosure describes generating prompts requesting GAI model validation of industrial design selections, including requesting alternate selection suggestions for irregular selections. The GAI model may respond with one or more alternate selection suggestions, which may be included in a notification displayed to the user.

### RELATED APPLICATIONS

This U.S. patent application is related to co-pending U.S. patent application entitled “PROFILE-BASED PROMPT ENGINEERING FOR USER-SPECIFIC INDUSTRIAL AUTOMATION PROJECT CUSTOMIZATION,” Attorney Docket Number 2024P-025-US, filed concurrently, the contents of which are incorporated herein in their entirety for all purposes.

This U.S. patent application is related to co-pending U.S. patent application entitled “INDUSTRIAL BASE DESIGN GENERATION USING GENERATIVE ARTIFICIAL INTELLIGENCE,” Attorney Docket Number 2024P-028-US, filed concurrently, the contents of which are incorporated herein in their entirety for all purposes.

This U.S. patent application is related to co-pending U.S. patent application entitled “UPDATING BASE DESIGNS IN INDUSTRIAL DESIGN APPLICATIONS USING GENERATIVE ARTIFICIAL INTELLIGENCE,” Attorney Docket Number 2024P-029-US filed concurrently, the contents of which are incorporated herein in their entirety for all purposes.

### TECHNICAL FIELD

The disclosure relates generally to utilizing Generative Artificial Intelligence (GAI) models, such as Large Language Models (LLMs) or Multi-Modal Models (MMMs), to validate industrial design selections, and more specifically to provide suggestions with respect to base design selections made by users in an industrial design application.

### BACKGROUND

In preparation for building, updating, or modifying industrial systems in a factory, an engineer may use an industrial design application to plan details, including selecting components (e.g., machines, controllers, cabinets, and the like), selecting configuration settings of the components, and designing layouts of the system. Once configured, the engineer can submit the design for quoting using the industrial design application. There are many configuration options for engineers to select in designing any portion of the system. Such options may include, for example, the types and models of components, unit configuration selections, levels of safety, mounting arrangements, and the like. Since engineers have varying levels of experience with the different configuration options, engineers sometimes make selections that are suboptimal or uncommon among other users designing systems for the same industry and location. The frequency of suboptimal design selections increases costs associated with the design process, for example, due to increased quality checks and revisions. If a suboptimal design selection is included in a finalized design of an industrial system, the quality of the system is reduced and the system takes longer to build. Furthermore, when an engineer chooses an uncommonly selected unit, lead time (the time between purchase and delivery) may be increased, since the manufacturer might not keep the unit in stock. Once the system is built, maintenance may become more difficult since maintenance teams might not keep uncommonly selected units in inventory.

Existing systems do not provide notifications or suggestions to users when the users make uncommon selections. Further, maintaining a database of all relevant common preferences is resource-intensive, cumbersome, and may be cost prohibitive.

### SUMMARY

This disclosure describes an industrial design application that assists users during the design of an industrial automation project. The industrial automation project may include designs of one or more industrial automation devices. The industrial design application may be utilized in the pre-sale phase of the industrial automation project, in which customers design the industrial automation project and submit requests for quotes for the designs. The industrial design application provides users with designs of industrial automation devices, and the design may include as few as one industrial automation device or as many as are needed to operate an entire factory. The industrial design application quickly provides users with unique designs for simple or complex industrial automation projects which users may customize within the industrial design application. The disclosed system leverages a Generative Artificial Intelligence (GAI) model, such as a Large Language Model (LLM) or Multi-Modal Model (MMM), to validate industrial designs selections users make within industrial design application.

Embodiments of the present disclosure describe a computer-implemented method for providing industrial design suggestions. The method includes receiving, via a user interface of an industrial design application, an industrial design selection from a user of a plurality of users of the industrial design application. The industrial design selection includes a selection of a configuration option in a design of an industrial automation project. The method further includes generating a prompt to elicit a reply from a General Artificial Intelligence (GAI) model trained on data including previous industrial design submissions from the plurality of users. The prompt includes a description of the industrial design selection and a request for the GAI model to compare the design with the industrial design selection against common selections learned from the previous industrial design submissions to identify uncommon selections. The method further includes submitting the prompt to the GAI model. The method further includes receiving, in response to the prompt, the reply including one or more alternate selection suggestions for the configuration option. The one or more alternate selection suggestions are representative of previous selections made in the previous industrial design submissions from the users of the industrial design application. The method further includes providing a notification to the user via the user interface, the notification including the one or more alternate selection suggestions.

In some embodiments, the notification further includes one or more selectable elements corresponding to the one or more alternate selection suggestions. The method further includes receiving, from the user in response to the notification, a user selection of a first of the selectable elements indicating an adoption of a first of the alternate selection suggestions. The notification further includes updating the design of the industrial automation project with the first of the alternate selection suggestions.

Some embodiments of the method further include providing the GAI model with static data during initial training. The static data includes one or more of: industrial product literature, industry standard data, and safety requirements data.

Some embodiments of the method further include receiving from a user, via the user interface, a request from a user for a design of the industrial automation project. Some embodiments further include providing to the user, via the user interface in response to the request, an initial design for the industrial automation project. The industrial design selection from the user includes a modification of the initial design provided to the user.

Some embodiments further include receiving from the user, via the user interface, a submission of a finalized design of the industrial automation project. The method further includes providing the finalized design to the GAI model for updating learned common selections among users of the industrial design application.

In some embodiments, the prompt further requests a brief narrative of a potential problem associated with the industrial design selection. The notification sent to the user further includes the brief narrative.

In some embodiments, the prompt for the GAI model further includes an industry and an install location for the industrial automation project. The prompt further includes a request to generate suggestions based on common user selections for designs submitted in the industry and the installation location.

### BRIEF DESCRIPTION OF THE DRAWINGS

FIG. 1 illustrates a system for industrial design assistance, according to some embodiments.

FIG. 2 illustrates a logical view of exemplary base design elements, according to some embodiments.

FIG. 3 illustrates a view of the cloud platform of FIG. 1, according to some embodiments.

FIG. 4 illustrates a method for updating a base design repository according to some embodiments.

FIG. 5 illustrates an operational scenario for the system of FIG. 1, according to some embodiments.

FIGS. 6A and 6B illustrate a method for providing industrial design selection recommendations, according to some embodiments.

FIG. 7 illustrates an operational scenario for the system of FIG. 1, according to some embodiments.

FIGS. 8D-8E illustrate example user interfaces for an industrial design application, according to some embodiments.

FIG. 9 illustrates prompt templates, according to some embodiments.

FIG. 10 illustrates an exemplary computing device, according to some embodiments.

### DETAILED DESCRIPTION

This disclosure relates to the use of a Generative Artificial Intelligence (GAI) model, (e.g., a Large Language Model (LLM) or Multi-Modal Model (MMM)), to provide industrial design suggestions to users of an industrial design application. The industrial design application assists users in the design and procurement of industrial automation projects. Industrial automation projects may include one or more industrial automation devices. Individual industrial automation devices may include, for example, drives, controllers, conveyors, and the like. An industrial automation project may include, for example, Motor Control Centers (MCCs), power distribution systems, and factory lines. These projects may include a combination of industrial automation devices including industrial automation drives, industrial automation controllers, a cabinet for the industrial automation devices, and the like. An industrial design project for an entire factory may include all industrial automation devices needed to operate a factory. The industrial design application quickly provides users with unique designs for industrial automation projects and provides the users with the ability to easily customize the designs. The industrial design application may be utilized in the pre-sale phase of industrial automation projects. In the pre-sale phase, the user accesses the industrial design application to design the industrial automation project and request a quote.

There may be many configurable options available in an industrial automation system such as a Motor Control Center (MCC). For example, when a user (such as an industrial engineer) is designing an MCC in the industrial design application, configurable attributes include the voltage and frequency of power provided to the MCC, the load utilization, the specific models of motor controllers desired, space factors, the type of operating stations for different types of motor controllers, safety standards such as arc fault certification requirements, among many other parameters. While several options for each of these attributes may be presented to users in the industrial design application, some options may not be commonly selected by users designing industrial automation projects in certain industries and locations. When an option is not commonly selected, the selection may be suboptimal, or there may be a potential problem associated with the selection. Due to the varying levels of experience among users of the industrial design application and the many configurable aspects of an industrial system, users may sometimes make selections that are not commonly made by other users designing projects in similar industries and locations. For example, a user may select a space factor in an MCC that is below the minimum space factor required by local regulations. Uncommon selections may increase costs in the design process, since it may extend review and quality control processes. Providing users with suggestions when uncommon selections are made may reduce costs in the design process and may result in higher quality design submissions from users. Providing suggestions also reduces lead time, since commonly selected components are more likely to be kept in stock by the manufacturer of the component. The time to build the industrial automation system is also reduced, since common configurations have established build procedures. Once built, the industrial automation system is easier to maintain, since maintenance teams are more likely to keep commonly selected units in stock. Additionally, the suggestions may provide guidance to novice users or users not familiar with the given constraints for that location and industry type. However, with the many configuration options involved in industrial automation projects, and since common selections may change over time and may differ in various industries and locations, it becomes unreasonable to maintain a database storing all relevant common selections.

To address the above-described issues, an improved industrial design application is disclosed that leverages a GAI model to perform common configuration validation for industrial design selections made by the users. The GAI model is trained on previous design submissions from the users of the industrial design application. From the training, the GAI model has learned knowledge of common user selections among users designing projects for various industries and locations. When a user of the industrial design application makes a design selection (for example, selecting a space factor for an MCC), the industrial design application generates a prompt requesting common configuration validation (i.e., determining whether or not the industrial design selection is commonly made by other users designing projects for similar industries and install locations, and generating suggestions). The GAI model may respond with a brief narrative alerting the user of any potential problems associated with the selection (e.g., the space factor selected does not comply with local regulations) and one or more alternate selection suggestions selectable by the user (e.g., a suggestion for using a higher space factor complying with the local regulations). When the industrial design application receives the response from the GAI model, it provides a notification to the user with selectable elements allowing the user to quickly adopt one of the alternate selection suggestions.

As such, the industrial design application of the present disclosure provides real-time feedback for users designing industrial automation systems in the industrial design application. The feedback decreases the chance that users of varying skill levels will submit designs with uncommon configurations, and reduces costs associated with review and quality control processes.

The improved industrial design application of the present disclosure also leverages the GAI model to update the base designs in the base design repository. The base design repository is a library of generic base designs, where each generic base design is a design of a fully functioning industrial unit. Generic base designs typically have configurations that align with common selections for a given industry and installation location. However, since common selections tend to change over time, the generic base designs in the base design repository may become outdated. The industrial design application leverages the GAI model to update the generic base designs to update the base designs to more closely align with common selections made by users configuring industrial designs. Updated base designs received from the GAI model have configurations that are more likely to align with current common selections made by users of the industrial design application. This increases the case of use for users since the initial designs they receive are more likely to be aligned with their request. As such, the number of alterations that users make to arrive at a finalized design is usually decreased. Furthermore, some users may not be familiar with various common selections made by other users. The model-updated base designs assist users in arriving at designs with optimal selections, even if the user would not otherwise have had the experience to make optimal selections.

Additionally, resource usage may be reduced using the disclosed systems. For example, common selections for all possible configuration options for various industries and locations do not need to be individually determined and stored. Furthermore, the disclosed systems may reduce operational costs, since the GAI model may accurately identify common selections in real-time, reducing the need for database maintenance and data analysis processing operations.

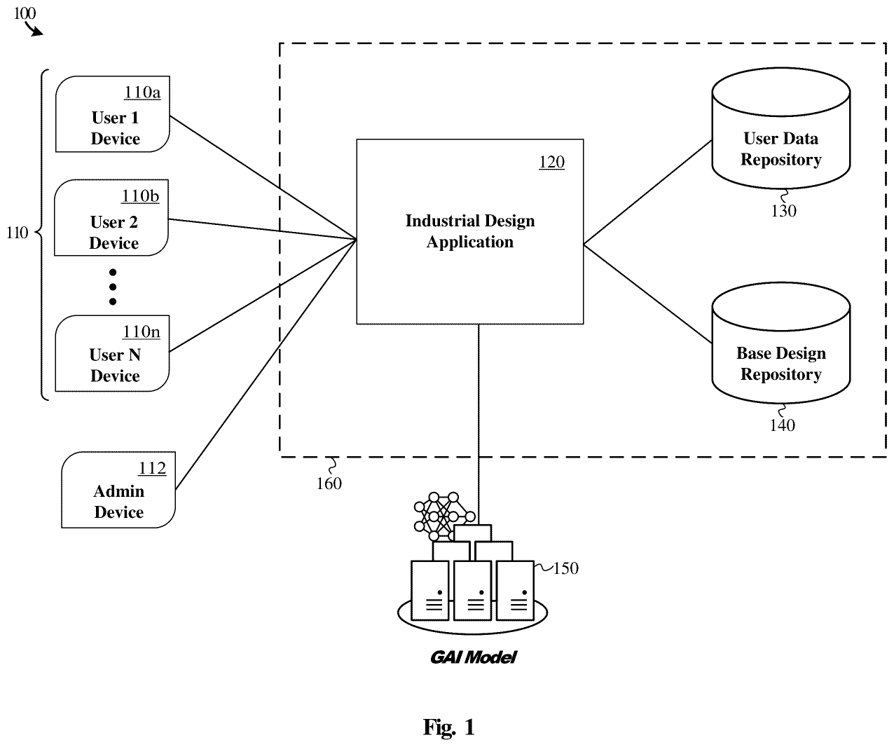

FIG. 1 illustrates system 100 according to some embodiments. System 100 includes user devices 110, admin device 112, cloud platform 160, and GAI model 150. While specific elements of system 100 are shown for case of description, system 100 may include more or fewer of each described component as well as other components not described for simplicity.

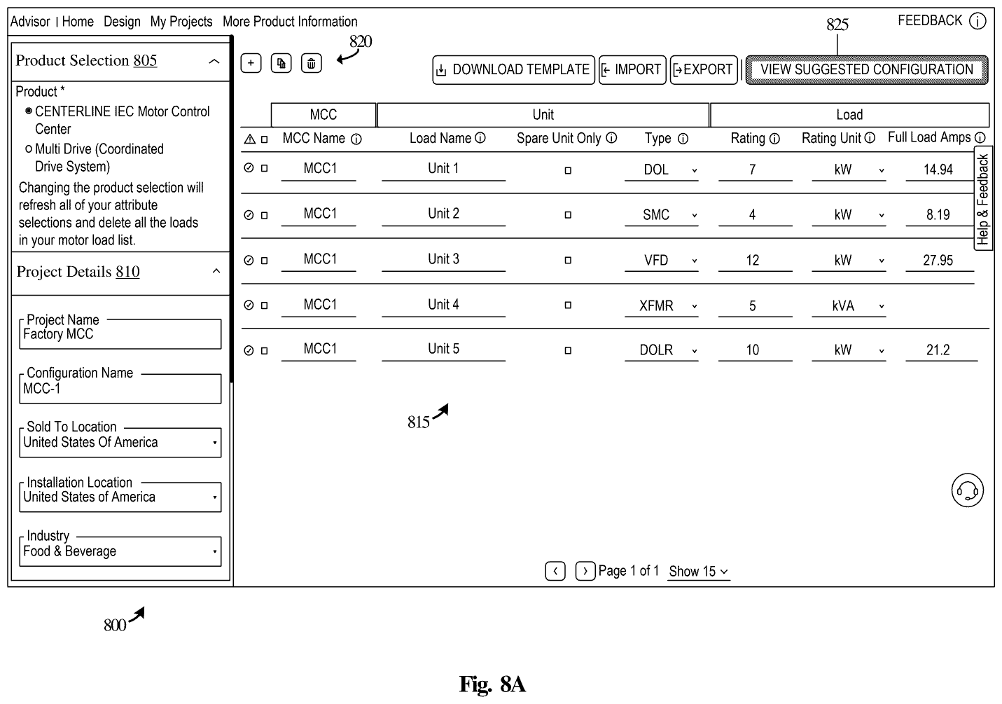

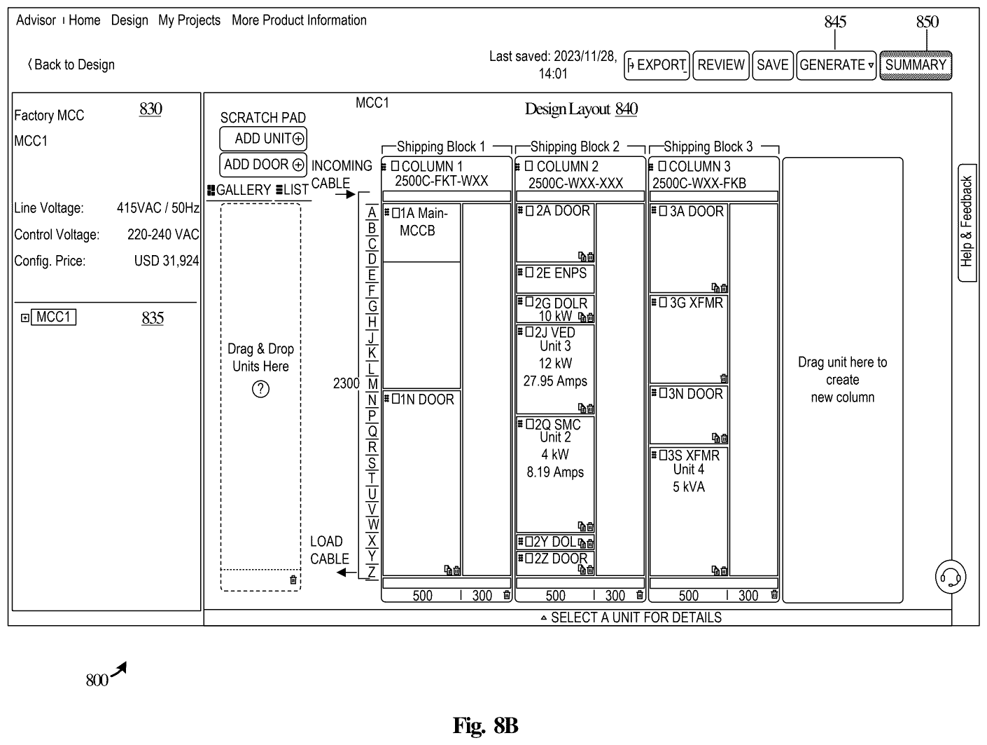

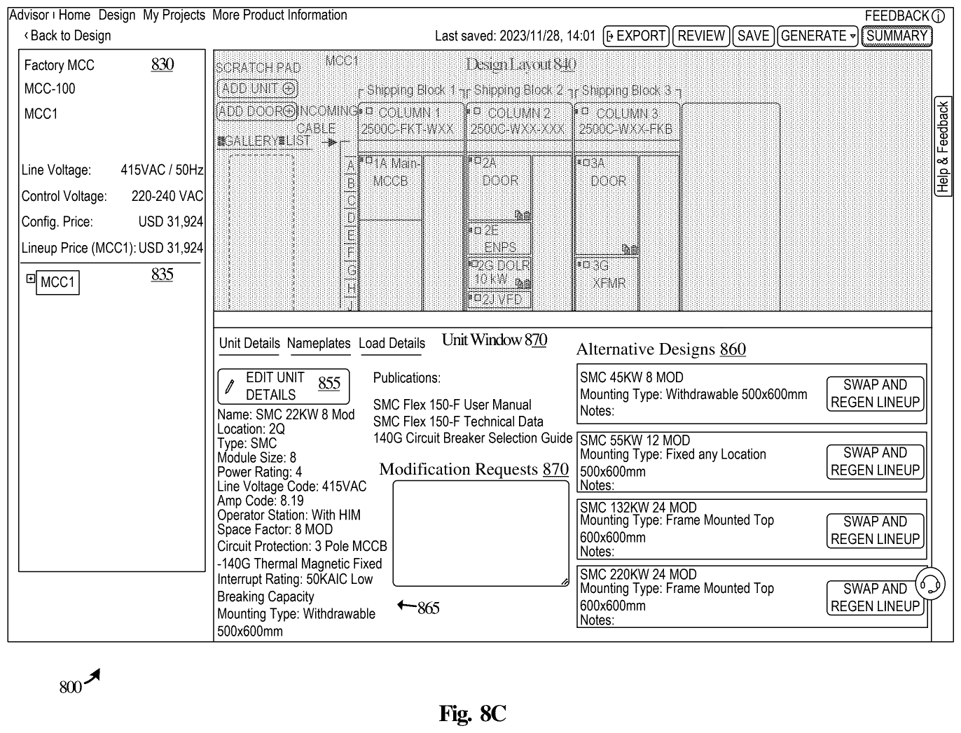

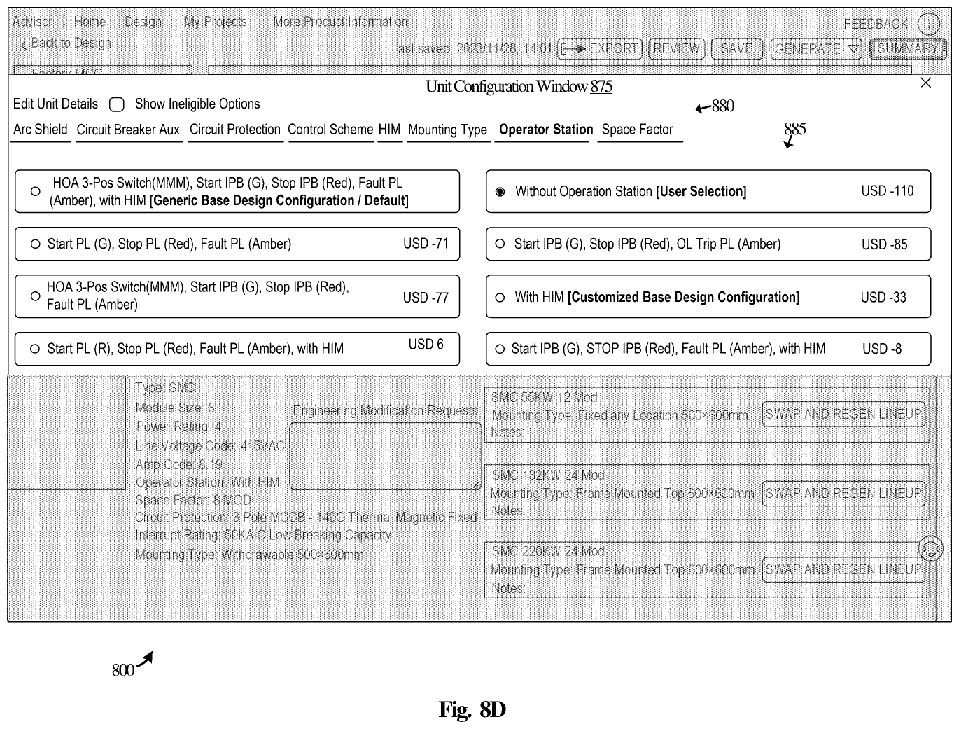

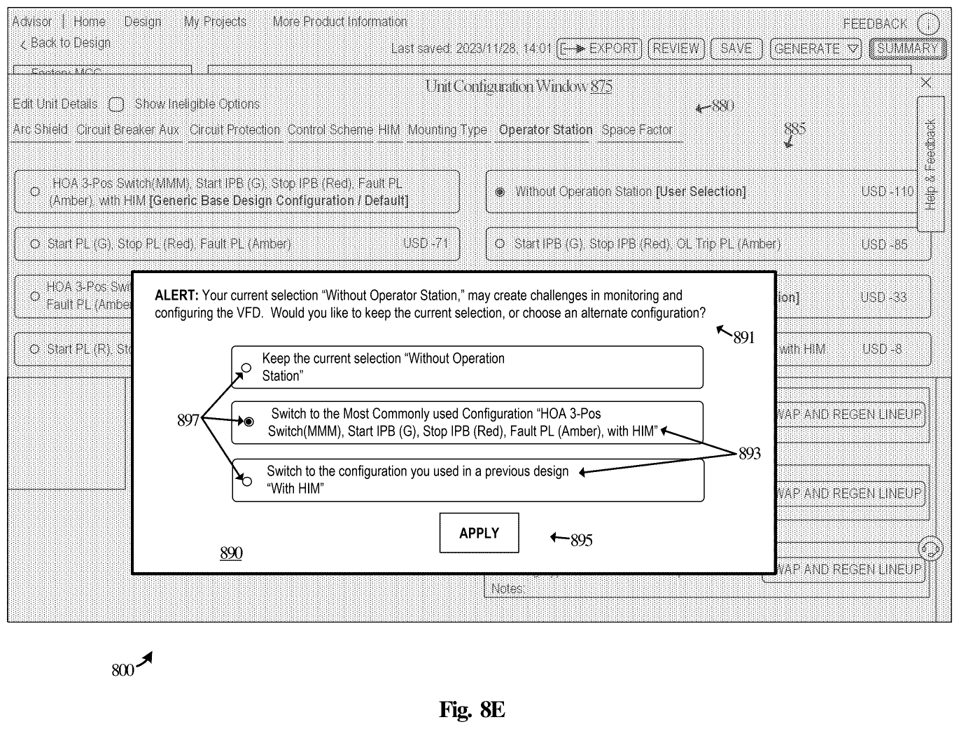

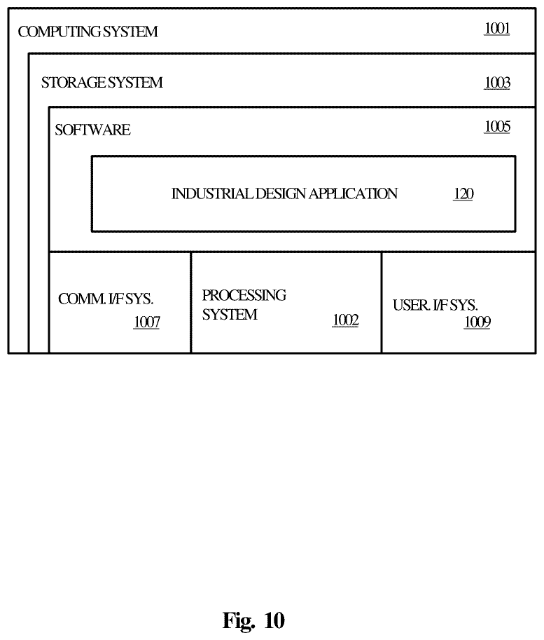

User devices 110 include user 1 device 110a, user 2 device 110b, and user N device 110n. While three user devices 110 are shown in FIG. 1 for simplicity, the system 100 may include any number N of user devices 110. User devices 110 may include computers, laptops, mobile devices such as smartphones or tablets, or any other similar device capable of interfacing with industrial design application 120. Users may access industrial design application 120 on user devices 110. Specifically, users may log in to a user account on a web browser on user device 110 to access the industrial design application. In some embodiments, the users may open an application program on user device 110 to access industrial design application 120. In either case industrial design application 120 provides a user interface to display to the user on user device 110. Exemplary user interfaces 800 are shown in FIGS. 8A-8D. User devices 110 may be computing device 1001 described with respect to FIG. 10.

A user may interact with the user interface on user device 110 to make a request for a design of an industrial automation project. Such a request may be made in the pre-sale phase of the industrial automation project. The industrial automation project may include one or more industrial automation devices, including a layout of physical components for installation, for example, on a factory floor. In the pre-sale phase, the user may design and configure the industrial automation project using the user interface on user device 110. Once the user is satisfied with the industrial automation project design, the user may request a quote for the designed industrial automation project (i.e., each of the configured industrial automation devices in the industrial automation project).

To make the request for the design, the user may input parameters of the industrial automation project in the user interface of user device 110. In some embodiments, the parameters include the relevant industry (such as “Automotive” or “Food/Beverage”) and the installation location, (e.g., country, city, region or the like) in which the industrial automation project is to be implemented. Parameters may also include a load list, setting forth the functionality of the industrial automation project. When the industrial automation project is an MCC, the load list may be a motor-load list, in which the user inputs the types of motor control units (e.g., Direct On Line (DOL) motor controllers and starters, Variable Frequency Drive (VFD), etc.) to be included in the MCC, as well as other relevant parameters such as the power rating for each motor controller. Once the user has input the parameters, the user may submit the request for the design of the industrial automation project via the user interface of user device 110.

In some embodiments, to make the request for the design, the user may upload a file (e.g., the process layout file or schematic file) as a parameter or even as the only parameter. The system may extract relevant data from the file including, for example, installation location, relevant industry, load list, and the like. The system may use artificial intelligence models, including GAI models, to extract the relevant data and otherwise interpret the file. In some embodiments, for example, the system may interpret the file by generating a prompt asking the GAI model to analyze the file and provide a summary of details including a bill of materials based on the user and the file. In some embodiments, the system may extract relevant data from the file using an AI model that is trained to extract particular data from the particular type of file, for example. The extracted data may be used as context for interpreting the file using an AI model trained to analyze the particular type of file (e.g., schematic file, process layout file, or the like) and generate a bill of materials based on the file. Based on the bill of materials, the user information, and any other parameters extracted or provided by the user, the system may select the relevant generic base designs.

Generated designs for the industrial automation project are provided to users via the user interfaces of user devices 110, in response to design requests. The generated design includes one or more customized base designs and an arrangement of the customized base designs including physical placement, connections, and the like when appropriate. The customization of base designs is discussed in further detail below. Each customized base design is a design for a fully functional industrial unit, customized by GAI model 150 based on learned user preferences. A fully functional industrial unit may be a single industrial automation device (e.g., a programmable logic controller, a drive, or the like) or it may be a combination of industrial automation devices arranged into a common configuration (e.g., a motor control center (MCC)). The generated design may include a complete layout for a set of customized base designs. A generated design for an MCC is shown, for example, in FIG. 8B, which includes an arrangement of motor controllers in a series of columns. Once the user receives the design, the user may make modifications to the generated design, as discussed in detail in FIGS. 8C and 8D below. For example, the user may modify configuration options, remove or add base designs for one or more industrial units, or the like. Once the user is satisfied with the design of the industrial automation project, the user may submit the finalized project. The submission of the finalized project may include, for example, a request for a quote. Users may also interact with the user interfaces of user devices 110 to perform other tasks such as submitting feedback, viewing help topics, reporting bugs, requesting live customer assistance, and viewing product catalogues, for example.

Once the user receives the design of the industrial automation project, the user may make modifications to the design, for example, in user interfaces 800 shown in FIGS. 8C and 8D. To make modifications, the user may make selections for various configurable options in the user interface of user device 110. For example, a user may swap out a unit for a different model of unit, may reconfigure settings within a unit, and may rearrange units within the system (e.g., adding new cabinets in an MCC or rearranging the layout of motor controllers in cabinets). If the user makes an uncommon selection (i.e., a selection that is not commonly selected by other users in the same industry and location), the user may receive a notification and suggestions displayed on the user interface of user device 110. An example notification on user device 110 is shown in user interface 800 of FIG. 8E.

Once the user is satisfied with the design of the industrial automation project, the user may submit a finalized design for the industrial automation project. The submission of the finalized project may include, for example, a request for a quote, or a request to purchase the industrial automation project. Users may also interact with the user interfaces of user devices 110 to perform other tasks such as submitting feedback, viewing help topics, reporting bugs, requesting live customer assistance, and viewing product catalogues, for example.

Admin device 112 is used by administrators to perform administrative tasks in industrial design application 120. While one admin device 112 is shown in FIG. 1 for simplicity, the system may include multiple admin devices 112 utilized by multiple administrators of industrial design application 120. Admin devices 112 may include computers, laptops, mobile devices such as smartphones or tablets, or any other similar device. Administrators may access industrial design application 120 via user interfaces on admin devices 112. The user interfaces may be viewed, for example, in web browsers or application programs. Functions performed by administrators may include updating software of industrial design application 120 and maintaining generic base designs in base design repository 140. Admin devices 112 may be computing device 1001 described with respect to FIG. 10.

Cloud platform 160 includes industrial design application 120, user data repository 130, and base design repository 140. Cloud platform 160 may optionally include Generative Artificial Intelligence (GAI) model 150 in some embodiments. Cloud platform 160 operates from servers which may be located in data centers, distributed in various geographic locations, and the like. Various software components of cloud platform 160 may have multiple instances in different geographic locations for redundancy and speed.

Industrial design application 120 includes software operating from servers in cloud platform 160. Industrial design application 120 may be a web-based application that assists users in the design of industrial automation projects. Industrial design application 120 may be utilized in the pre-sale phase of industrial automation projects. In the pre-sale phase, industrial design application 120 assists users in designing and configuring the industrial automation projects and provides quotes to the users for the industrial automation projects. Industrial design application 120 generates a design of industrial units in industrial automation projects based on parameters defined by the user. For example, in the process of assisting in the design of an MCC, industrial design application 120 may generate a layout of motor controllers and other components (e.g., circuit breakers and power buses) to meet the parameters of a user's design request.

Industrial design application 120 interacts with user devices 110, admin devices 112, user data repository 130, base design repository 140, and GAI model 150 to perform various functions as discussed below. Industrial design application 120 may be computer software implemented on one or more servers and/or in a cloud-based environment. Industrial design application 120 may be implemented in memory on a server such as, for example, computing device 1001 as described with respect to FIG. 10.

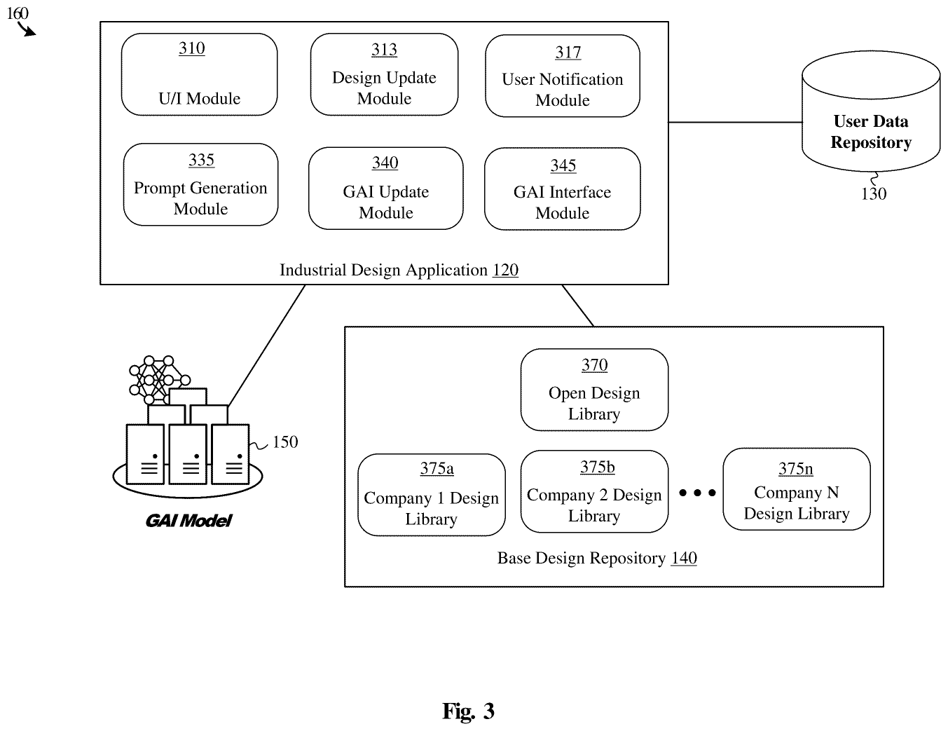

Industrial design application 120 receives requests from users for designs of industrial automation projects. Such requests may include parameters defined by users, as discussed above. Based on the parameters in the user request, industrial design application 120 may select generic base designs from base design repository 140 to include in an initial design of the industrial automation project. For example, in the case in which the request is for the design of an MCC, industrial design application 120 selects a generic base design for a motor controller for each load included in the motor-load list of the user's request. The selection of a generic base design is based on the type of motor controller requested (e.g., VFD) as well as other stated attributes (e.g., power ratings) in the parameters. Industrial design application 120 generates a layout for the industrial automation project including the generic base designs selected. Once the layout for the industrial automation project is generated, industrial design application 120 displays the layout to the user via the user interface of user device 110. Industrial design application 120 may receive design selections from the user, where the design selections are modifications of industrial design application 120 made by the user in the user interface of user device 110. Industrial design application 120 may generate a prompt requesting GAI model 150 review the selections as discussed in greater detail in method 600 below. Industrial design application 120 also initiates updates base designs in base design repository 140, as discussed in greater detail in method 400 below. Furthermore, FIG. 3 includes additional details of the functionalities performed by industrial design application 120.

User data repository 130 is a database storing information about each user of industrial design application 120. In some embodiments, user data repository 130 may include basic information about each user such as login information, contact information, and the user's organization or company. User data repository 130 may also include historical user data including previous industrial design configurations submitted by the user, and previous products purchased by the user. This historical user data may be provided to GAI model 150 for training, as discussed in further detail method 400 below. The user data in user data repository 130 may be stored in memory of a server or other data storage device of cloud platform 160.

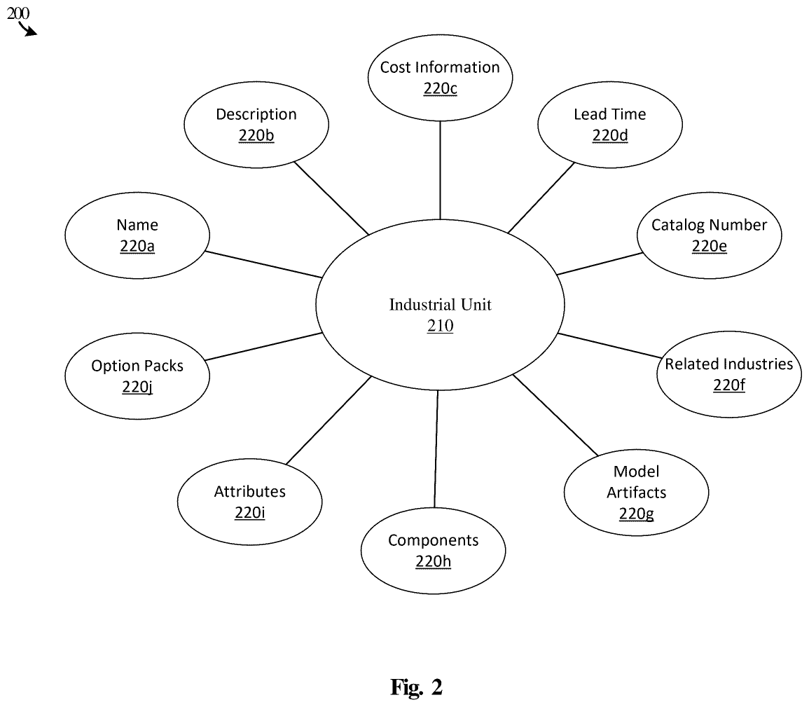

Base design repository 140 is a database that may contain generic base designs of industrial units. Industrial units include one or more industrial automation devices and are described in more detail with respect to FIG. 2. Each generic base design in base design repository 140 includes a generic design configuration for a fully functional industrial unit. The generic base designs in base design repository 140 may be base design 200 of FIG. 2. Metadata for each generic base design, for example metadata 220 of FIG. 2, is stored in base design repository 140. Metadata includes detailed information defining a fully functional industrial unit, as discussed further in FIG. 2 below. The metadata may include option packs (e.g., option packs 220j of FIG. 2) for the industrial units. Option packs include various options for configurable aspects of the industrial unit. For example, a base design for a VFD could include an “Operator Station” option pack. A user may thus choose between different types of operator stations, such as an operator station having a Human Interface Module (HIM), or an operator station having a combination of a HIM and indicator lights. Each option pack may include a default selection. GAI model 150 may customize base designs by altering selections within option packs based on the request in the prompt, as discussed in further detail below. As noted above, the metadata of the generic base designs are utilized by industrial design application 120 for generating prompts requesting user-specific customization from GAI model 150. The generic base designs in base design repository 140 be stored in memory of a server or other data storage device of cloud platform 160.

The generic base designs in base design repository 140 are designed to be aligned with common configuration selections among users of industrial design application 120. For example, in the textile industry, users often select fixed mounting for motor controllers to provide better sealing from particulate matter in the environment. As such, generic base designs with “textiles” as a relevant industry may generally include fixed mounting arrangements for motor controllers. With changing industrial design practices, some common selections may change over time. To keep the generic base designs in base design repository 140 up to date with current common selections, industrial design application 120 may leverage GAI model 150 to update the generic base designs, as discussed in further detail in method 400 below.

GAI model 150 is a generative artificial intelligence model trained to perform industrial design tasks. GAI model 150 may include a system of transformer-based neural networks with a vast number of parameters (e.g., weights and balances). The parameters may be adjusted during training for learning information, including industrial data and common selections among users of industrial design application 120. Training of GAI model 150 is discussed in further detail in method 400 below. GAI model 150 may be a large language model (LLM) trained on a vast amount of textual data. An LLM is capable of processing textual inputs to generate textual outputs. In some embodiments, GAI model 150 is a Multi-Modal Model (MMM). An MMM may be trained on a vast number of various types of data, including, for example, textual data, video, audio, images, 3-D renderings, CAD files, and other various forms of media. An MMM may be capable of processing inputs and generating outputs in each of these formats. GAI model 150 may be implemented on a computing system (e.g., computing device 1001 of FIG. 10), typically in a cloud-based environment due to the processing and memory resources needed to support GAI model 150. However, on-premises implementations are within the scope of this disclosure. Further, GAI model 150 is depicted outside of cloud platform 160. However, in some embodiments, GAI model 150 may be hosted within cloud platform 160, for example, as an enterprise-specific instance.

GAI model 150 receives prompts from industrial design application 120 requesting review of industrial design selections from users. A prompt, generated by industrial design application 120, may include a description of an industrial design selection and a request to respond with alternate selection suggestions if the industrial design selection is an uncommon selection among various users. GAI model 150 is trained to review design selections and generate suggestions, as discussed in greater detail in method 600 below.

Industrial design application 120 leverages GAI model 150 to keep the generic base designs up to date with common selections among various users. As such, GAI model 150 may periodically update the generic base designs based on learned common industry preferences. The updating of generic base designs is discussed in greater detail below. It is noted that GAI model 150 may also provide user-specific customization of base designs from base design repository 140, as discussed in greater detail in related applications incorporated by reference above.

GAI models (also known as foundation models) are models trained to generate new data based on a training dataset. GAI models as used herein include large-scale generative artificial intelligence (AI) models trained on massive quantities of diverse, unlabeled data. The GAI models learn using self-supervised, semi-supervised, or unsupervised techniques. GAI models perform many downstream tasks based on capturing general knowledge, semantic representations, and patterns and regularities in the training data. In some embodiments, such as embodiments included herein, a GAI model may be fine-tuned for specific downstream tasks. GAI models include BERT (Bidirectional Encoder Representations from Transformers) and ResNet (Residual Neural Network). GAI models may be based on any relevant architecture, including, for example, generative adversarial networks (GANs), variational auto-encoders (VAEs), and transformer models, including multimodal transformer models. Depending on the type of input accepted and output provided, GAI models may be multimodal or unimodal.

Multimodal models are a class of GAI models that accept multimodal data including text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of a given image by extracting visual features using an image encoder, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video-generating a text description of the video or generating video based on a text description.

Multimodal models include visual-language foundation models, such as CLIP (Contrastive Language-Image Pre-training), ALIGN (A Large-scale ImaGe and Noisy-text embedding), and ViLBERT (Visual-and-Language BERT), for computer vision tasks. Examples of visual multimodal or foundation models include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a type of GAI model that process and generate natural language text. These models are trained on massive amounts of textual data. LLMs learn to generate relevant responses given a prompt or input text. The responses are coherent and contextually relevant to the given prompt. LLMs understand and generate sophisticated language based on their training. LLMs capture intricate patterns, semantics, and contextual dependencies in textual data. In some cases, LLMs may be used in multimodel models. For example, the LLM intelligence is used to combine images and audio input with textual input to generate multimodal output. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge Integration) models, T5 (Text-to-Text Transfer Transformer), and XLNet models are types of transformer models which have been pretrained on large amounts of text data using a self-supervised learning technique called masked language modeling. For example, large language models, such as ChatGPT and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses that are creative, open-ended, and unpredictable.

In practice, industrial design application 120 may initiate an update of a generic base design from base design repository 140. Industrial design application 120 may initiate the update based on a determination that a predetermined time-period has elapsed. For example, the predetermined time-period may be one year, three months, or one month. It is noted that other time periods may be used in various embodiments. The predetermined time period is set to ensure that the generic base designs stay up to date with changing industry preferences. In some embodiments, industrial design application 120 may also initiate an update of a generic base design based on a request received from admin device 112 to update one or more generic base designs selected from base design repository 140.

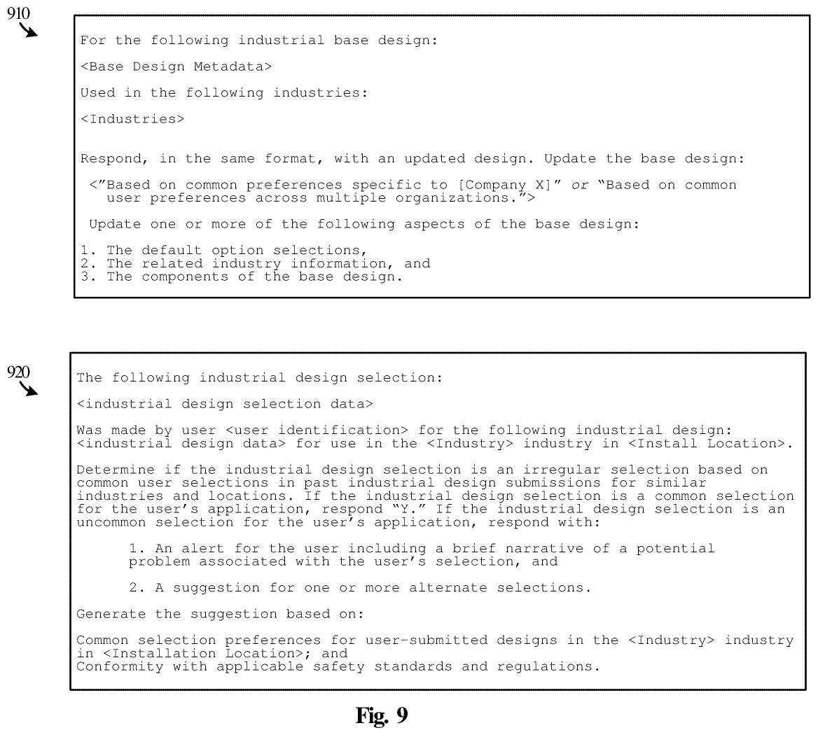

Once industrial design application 120 initiates an update, industrial design application 120 generates a prompt for GAI model 150 to update the generic base designs based on common industrial preferences. The prompt includes some or all of the metadata (e.g., metadata 220 of FIG. 2) of the generic base design retrieved from base design repository 140. The prompt further includes a request to respond with an updated base design based on common selections among various users of industrial design application 120. Exemplary prompt template 910 in FIG. 9 shows a prompt template utilized for prompt generation.

Industrial design application 120 submits the prompt to GAI model 150. GAI model 150 generates an update of the generic base design based on common selections of users. GAI model 150 responds to industrial design application 120 with the updated metadata for the updated base design. The updated base design may then be provided to an administrator or engineer, such as an engineer on admin device 112, for review of the updated base design. The engineer may review the updated base design to ensure it aligns with industry standards and applicable laws and regulations. If the engineer approves of the updated base design, the engineer submits an indication of approval to industrial design application 120. When industrial design application 120 receives the approval, industrial design application 120 adds the updated based design to base design repository 140. The updated base design may then be provided as initial suggestions to users in response to future requests by users for designs of industrial automation projects. As such, the base designs provided to the user are up to date with current common selections, thus increasing the quality of designs created by users and increasing the case of use of the application. In some embodiments, the original base design may remain in base design repository 140 along with the updated base design until an administrator reviews the original base design. Upon review, an administrator may determine to remove the original base design (e.g., if it has become outdated) or keep in in base design repository 140 as an alternative to the updated base design. As such, industrial design application 120 does not remove the original base design without administrator approval, according to some embodiments.

As noted above, GAI model 150 may also be leveraged to review user selections within industrial design application 120. In this scenario, a user may log into industrial design application 120 via a web browser or app on a user device such as user device 110a. In designing an industrial automation system, the user makes many design choices. In MCC design, a user may make a configuration selection by swapping out a motor controller for a different model motor controller, as demonstrated in FIG. 8C. Additionally, a user may elect to make alternate configuration selections of options within the motor controller, as demonstrated in FIG. 8D. Each industrial design selection made by the user may be submitted to GAI model 150 for review. As such, when industrial design application 120 receives a user selection, it generates a prompt for GAI model 150. The prompt includes data describing the user selection. Contextual information included in the prompt may include the design selection itself, the entire industrial design, the relevant industry, and the installation location. The prompt may also include a request to generate an alert and alternative selections if the design selection is an irregular selection. A prompt template, such as prompt template 920 of FIG. 9, may be used to generate the prompt.

Once industrial design application 120 generates the prompt, industrial design application 120 submits the prompt to GAI model 150. GAI model 150 reviews the selection. If GAI model 150 determines that the selection is an uncommon selection among users of industrial design application 120, GAI model 150 generates an alert and one or more alternate selection suggestions for the user. After receiving the alert and alternate selection suggestions, industrial design application 120 generates a notification for the user including the alert and suggestions. The notification is sent to the user on user device 110a. FIG. 8E shows an example notification 890. The user may elect to adopt one of the suggestions generated by GAI model 150. If the user adopts a suggestion, the design of the industrial automation project is updated in industrial design application 120.

FIG. 2 illustrates a schematic view of base design 200 according to some embodiments. Base design 200 contains detailed design data about a specific industrial unit 210. Base design 200 of FIG. 2 may be representative of the generic base designs stored in base design repository 140 of FIG. 1. Base design 200 may also be representative of the customized base designs provided to users, as described in related applications incorporated by reference above. Base design 200 includes industrial unit 210 and metadata 220. Metadata 220 includes name 220a, description 220b, cost information 220c, lead time 220d, catalog number 220e, related industries 220f, model artifacts 220g, components 220h, attributes 220i, and option packs 220j. Metadata 220 may be representative of metadata in base design 200, however base design 200 may include additional metadata 220 or less metadata 220 without departing from the scope of the present disclosure.

Industrial unit 210 of base design 200 represents a design for a fully functional industrial unit 210. Industrial unit 210 may be represented in a CAD file or blueprint stored in base design repository 140. In the context of an MCC, industrial unit 210 may be, for example, an industrial automation device such as a circuit breaker, a drive, or any other industrial unit 210 included in an MCC. Industrial unit 210 may include sub-components, in some examples. For example, a Direct On-Line (DOL) motor controller may include an arrangement of auxiliary contacts. In addition to the sub-components, the DOL may include other parameters including, for example, a control scheme, a mounting type, an operator station, a specific overload type, and a safety category. Industrial unit 210 may also be a broader unit such as a cabinet of an MCC, with an arrangement of various motor controllers and other components such as power buses within the cabinet. In an even broader sense, industrial unit 210 may be a fully functional MCC, with an arrangement of motor controllers and other industrial automation devices, arranged with relevant connections, in multiple cabinets. As such, base design 200 may define various levels of designs, from individual industrial automation devices (e.g., circuit breakers) to an entire factory of industrial automation devices including their connections and relationships, and everything in between (e.g., an MCC). Base design 200 may be provided to users in response to requests from users to generate an industrial automation project. For example, if a user makes a request for a design of an MCC, industrial design application 120 may generate a design for an MCC by selecting several base designs 200, requesting customized base designs from GAI model 150, and generating a layout of the customized base designs to create a fully functional MCC design customized for the specific user. Alternatively, base design repository 140 may include a base design for an MCC that can be customized by GAI model 150 to meet the parameters of the user's request based on the generated prompt. In either case, a user-specific customized design for a fully functional MCC may be generated. A user may further modify the design once the user views the design in industrial design application 120 by changing various selectable options within the design.

Metadata 220 collectively refers to metadata 220a-220j of base design 200. Metadata 220 includes detailed information about industrial unit 210, which may be stored in one or more taxonomy files. The taxonomy files may include spreadsheets, CAD files, electrical schematic blueprints, and other diagrams and file types for storing the information about industrial unit 210. Specific examples of metadata 220 are provided, but any variation may be used to describe industrial unit 210 without departing from the scope of the present disclosure.

Metadata 220 may include name 220a of industrial unit 210. Name 220a may include, for example, the unit type (e.g., VFD) in addition to an identifying model number. In other examples, a model number, a type of device, or any other name may be used.

Metadata 220 may include description 220b. Description 220b may include high-level information about industrial unit 210, as shown, for example, in the high-level overview of the configuration list 865 of FIG. 8C. Description 220b may also include detailed industrial specifications for industrial unit 210 in some embodiments.

Metadata 220 may include cost information 220c indicating the cost of industrial unit 210, including various price changes for selections of different selectable options, for example, within option packs 220j discussed below.

Metadata 220 may include lead time 220d, the time-interval between the purchase and delivery of industrial unit 210.

Metadata 220 may include one or more catalog numbers 220e associated with the unit. Catalog numbers 220e identify industrial unit 210 and are used for organizing industrial units in a product catalog.

Metadata 220 may include related industries 220f, indicating which industries the industrial unit design is suitable for (for example, the metals industry or the food and beverage industry).

Metadata 220 may include model artifacts 220g. Model artifacts 220g include models of industrial unit 210 and may include, for example, CAD files, electrical schematics, single-line diagrams, and mechanical models of industrial unit 210. Model artifacts 220g may further include a layout of industrial unit 210 illustrating, for example, how industrial unit 210 is laid out in a grid.

Metadata 220 may include components 220h, including information about the subcomponents included in industrial unit 210. For example, some of the subcomponents of a motor controller may include control circuitry, an operator station, a circuit breaker, and a housing.

Metadata 220 may include attributes 220i, storing information about the capabilities of industrial unit 210, such as maximum power ratings.

Metadata 220 may include option packs 220j. Metadata 220 may include one or more option packs 220j, where users can select various options within each option pack. An example option pack is represented in FIG. 8D. Alternatively, when the base design is a design for an MCC cabinet or an entire MCC, the option pack may include information about various substitutable components (such as motor controller models that are substitutable for the motor controller models included in the base design. Each option pack may have a default selection. In generating customized base designs, GAI model 150 may make alternate selections of options within option packs based on learned user preferences. As noted above, metadata 220 included in FIG. 2 is representative only; other embodiments may include additional elements, fewer elements, or any combination of various elements.

In practice, base design 200 may be a generic base design stored in base design repository 140 3. Industrial design application 120 retrieves some or all of metadata 220, for inclusion in a prompt for GAI model 150. Industrial design application 120 includes some or all metadata 220 in a prompt requesting an update of base design 200 based on common selections made by users of industrial design application 120. GAI model 150 responds to industrial design application 120 with updated metadata aligning with learned common design selections made by users. Industrial design application 120 then updates base design 200 by replacing the original metadata 220 with the updated metadata in base design repository 140.

FIG. 3 illustrates cloud platform 160 according to some embodiments. Cloud platform 160 includes industrial design application 120, user data repository 130, base design repository 140, and GAI model 150. Cloud platform 160 may be implemented on servers in a datacenter, distributed geographically, and/or the like. Note that GAI model 150 is depicted as part of cloud platform 160 in FIG. 3, however, this is an optional configuration as discussed above with respect to FIG. 1. GAI model 150 may be hosted within cloud platform 160 or externally without departing from the spirit and scope of this disclosure.

User data repository 130 is a database storing information about each user of industrial design application 120. User data repository 130 includes basic information about each user including login information, contact information, and the user's organization or company. User data repository 130 may also include historical user data including previous industrial automation project designs submitted by the user, and previous products purchased by the user. The historical data in user data repository 130 may be used to train GAI model 150 to learn user-specific preferences for each user, as well as common industrial preferences.

Base design repository 140 is a database of generic base designs. Base design repository 140 may include open design library 370. Open design library 370 is a library of generic base designs (e.g., base designs 200 described with respect to FIG. 2) that may be provided to any user of industrial design application 120 regardless of company affiliation. Base design repository 140 also includes company specific design libraries including Company 1 Design Library 375a, Company 2 Design Library 375b, and Company N Design library 375n (collectively “Company Design Libraries 375” for N number of companies). For example, Company 1 Design Library 375a contains generic base designs specific to Company 1, the Company 2 Design Library 375b contains generic base designs specific to Company 2, and the Company N Design Library 375n contains generic base designs specific to Company N (for any number N of companies that have specific design libraries). Storing company specific generic base designs allows industrial design application 120 to provide company specific customization to users of industrial design application 120. For example, a specific company may design preferences that are not commonly practiced by designers in other organizations. Furthermore, this arrangement allows for the protection of intellectual property such as trade secrets, as a company specific generic base design will not be provided to users who are not affiliated with the company.

Base design repository 140 may include any number of generic base designs. For example, in various embodiments, base design repository 140 may include on the order of hundreds or thousands of generic base designs. Each generic base design is stored either in Open Design Library 370 or one of Company Design Libraries 375. The generic base designs may be the base design 200 of FIG. 2. Generic base designs are designs of fully functioning industrial units (e.g., Industrial Unit 210 described in detail with respect to FIG. 2) which may be included in an industrial automation project. Each generic base design may include an arrangement of sub-components including control components, operator interface components, and mounting components. Taxonomy files associated with each base design may include details about the base design including cost information, bill of materials (BOMS) for the base design, and option packs. In the context of an MCC, a base design may be a power component, or a motor control unit tailored for a specific application. For example, a base design may be motor control unit tailored for a specific type of pump, conveyor, or mixer in an industrial environment.

Each generic base design in base design repository 140 may be used in an industrial automation project. Specifically, each generic base design includes a default configuration including default selections for configurable attributes. As described in method 400 below, industrial design application 120 may leverage GAI model 150 to update the generic base designs in base design repository 140. The updates to the generic base designs may include, for example, updating default selections of configuration options, updating related industry information, or updating components within the generic base design. These examples of updates to the generic base designs are exemplary; the generic base designs may be updated in other ways including modifying other types of metadata, adding or removing metadata, and the like.

As an example, a generic base design for a Variable Frequency Drive (VFD) may include the model of VFD, the type of circuit breaker (e.g. thermal-magnetic), a mounting type (e.g., withdrawable or fixed), the interrupt rating, a space factor indicating the amount of space the VFD will occupy in a cabinet, a type of operator station (e.g., the inclusion of door pushbuttons, indicator lights, and Human Interface Modules), the type of Human Interface Module (HIM) if a HIM is used, whether or not an EMC (Electromagnetic Compatibility) filter is included, the type of line reactor, and the safety category. GAI model 150 may update the base design of the VFD to have different default selections for one or more of the configurable attributes have different selections than the selections in the generic base design. For example, the initial generic base design may include a thermal-magnetic circuit breaker. The GAI model 150 may have learned, based on training and feedback, that users usually switch to an electronic circuit breaker. Thus, when the GAI model 150 receives a request to update the generic base design for the VFD, the GAI model 150 may update the VFD to include an electronic circuit breaker as the default selection, to align with common selections made by users. As another example, the generic base design for the VFD may include several related industries. The GAI model 150 may have learned that users in a certain industry such as the Food and Beverage industry usually swap out the VFD for a different model. As such, the GAI model 150 may remove the Food and Beverage from this list of related industries when it updates the generic base design.

Each generic base design may be designed by an engineering team to be tailored to a specific application. Generic base designs may also be generated by GAI model 150 and reviewed by engineers before being added to base design repository 140. Due to the vast number of possible combinations of the configurable attributes, it is impractical to store every possible configuration as a generic base design. Rather, the generic base designs are starting points from which the user may further configure to customize their design. It is noted that in some embodiments, GAI model 150 may also generate user-specific customized base designs based on the generic base designs, as described in greater detail in related applications incorporated by reference above.

Each generic base design in base design repository 140 includes option packs, (e.g., option packs 220j of FIG. 2 and option packs 880 of FIG. 8D). An option pack may have multiple selectable options and a default selection of one of the options. For example, an option pack for a circuit breaker of a motor controller may have a default selection option of “thermal-magnetic circuit breaker.” A user may customize generic base designs in an industrial automation project by making industrial design selections, including switching to different options within option packs. For example, a user may switch from “thermal-magnetic circuit breaker” to another option in the option pack, including “thermal circuit breaker.” When a user makes an industrial design selection in an option pack of a generic base design, industrial design application 120 generates a prompt for GAI model 150 requesting the GAI model to compare the industrial design selection against common selections made by other users of the industrial automation project. The process of requesting reviews of industrial design selections is discussed in greater detail in method 600 below.

GAI model 150 is a large artificial intelligence model trained to perform industrial design tasks for industrial design application 120. GAI model 150 may be an LLM or an MMM as discussed above. GAI model 150 may include multi-layered transformer architecture with many parameters (e.g., weights and biases) encoding information. GAI model 150 may be created by training a base model to perform industrial design functions. Such a base model may be licensed and hosted by a third party. Alternatively, the base model may be purchased or provided as an open-source model. Base models have generally been pre-trained on a vast amount of data. However, even though a base model may be pre-trained, it is generally not specifically trained to perform industrial design tasks. As such, initial training to perform industrial design functions may be performed to fine-tune the model to perform industrial design tasks. After the initial training, the model may be further trained to provide user-specific customizations. The training process for GAI model 150 is discussed in greater detail below.

While GAI model 150 is described here as updating generic base designs and reviewing user selections, it is noted that GAI model 150 may also perform other industrial design tasks. For example, GAI model 150 may be trained to generate user-specific customized base designs, generate new generic base designs for emerging industries, and provide competitive product matching functions. These functions are described in greater detail in related applications incorporated by reference above.

Industrial design application 120 is a web-based application used to design industrial automation projects in the pre-sale phase of industrial automation projects, as discussed in FIG. 1 above. Industrial design application 120 interfaces with user data repository 130, base design repository 140, GAI model 150, and user devices 110 (not shown in FIG. 3, see FIG. 1). Industrial design application 120 includes a User Interface (U/I) Module 310, Design Update Module 313, User Notification Module 317, Prompt Generation Module 335, GAI Update Module 340, and GAI Interface Module 345. Further, while these modules are depicted to describe the generation of design layouts of industrial design application 120, the functionalities described may be incorporated into more or fewer components, software components, hardware components, firmware components, or a combination without departing from the scope and spirit of the present disclosure. Each of the modules is discussed in turn below.

User Interface (U/I) Module 310 interfaces with user devices 110 and admin devices 112 (see FIG. 1) to generate and provide displays, and to receive inputs from users and administrators. U/I Module 310 sends information for rendering the user display on user devices 110 and admin devices 112. U/I Module 310 receives design selections and other inputs from users for designs of industrial automation projects (for example: requests for quotes, process requests for customer assistance, and process customer feedback comments). U/I Module 310 may also receive a request for a design including several user-selected parameters, as shown, for example in user interface 800 of FIG. 8A. In the case of an MCC, the user request may include a motor-load list, in addition to the industry and installation location for the MCC. Once industrial design application 120 generates an initial design in response to a user request, U/I Module 310 provides an initial layout for the industrial automation project to user device 110 (see FIG. 1). An example initial layout is represented in FIG. 8A. One the user receives the initial layout of the industrial automation project, the user may reconfigure certain aspects of the designs, by making industrial design selections. Industrial design selections may include, for example, swapping components or choosing different configuration selections. See, for example, the configuration selections available in FIGS. 8C and 8D. Each such configuration selection made by the user is received by U/I Module 310, then utilized by Prompt Generation Module 335 as discussed below. U/I Module 310 may also perform various other tasks associated with interfacing with users. For example, the U/I Module 310 may process requests for quotes, process requests for customer assistance, and process customer feedback comments.

Design Update Module 313 makes determinations for generic base designs in the base design repository 140 to be updated and initiates updates of the generic base designs. In one example, Design Update Module 313 initiates an update by determining that a predetermined time-period has elapsed since the last update of the generic base design. As such, Design Update Module 313 monitors the length of time that has elapsed since the last update for each generic base design in base design repository 140. When the predetermined time-period has elapsed for a specific generic base design, Design Update Module 313 initiates an update of that generic base design. The predetermined time period is any time period to provide that the generic base design stays up to date with industry preferences. The predetermined time period may be, for example, one month, three months, or one year. An update of a generic base design may also be initiated, for example, by request from an administrator. Specifically, an administrator on admin device 112 (see FIG. 1) may send a request to industrial design application 120 to update a generic base design in base design repository 140 based on common selections among users.

Prompt Generation Module 335 generates prompts for GAI model 150. Prompt Generation Module 335 uses prompt templates, such as prompt templates 910, 920 of FIG. 9, to generate prompts. The prompt templates may include a combination of text and placeholders, as shown in the exemplary prompt templates 910, 920 of FIG. 9. Various prompt templates may be stored in a memory storage of Prompt Generation Module 335, each prompt template being associated with a specific task for GAI model 150 (e.g., review of design selections, base design updates, base design customization, etc.). During prompt generation, Prompt Generation Module 335 selects an appropriate prompt template from the memory storage. For example, when Design Update Module 313 initiates an update of a generic base design, Prompt Generation Module 335 selects a prompt template for requesting a base design update from GAI model 150, such as prompt template 910 of FIG. 9. When U/I Module 310 receives a design selection from a user of the industrial design application, the Prompt Generation Module 335 selects a prompt template for requesting GAI model 150 to review design selections, such as prompt template 920 of FIG. 9.

Prompt Generation Module 335 may select a base design update prompt template, such as prompt template 910 of FIG. 9, when Design Update Module 313 initiates a base design update. To generate the prompt for an update of a generic base design, Prompt Generation Module 335 retrieves some or all the metadata for the generic base design from base design repository 140 for insertion into the prompt template. The metadata for the generic base design may be metadata 220 of FIG. 2. In some embodiments, Prompt Generation Module 335 may retrieve metadata 220 stored in base design repository 140. However, in other embodiments, Prompt Generation Module 335 only retrieves some of metadata 220. It is noted that there may be some stored metadata 220 for generic base designs that have comparatively less relevance with respect to updating the base designs. For example, the Catalog Number 220e may not be relevant contextual information for GAI model 150 in generating updated base designs. Other metadata 220 such as option packs 220j, components 220h, and related industries 220f, are more relevant contextual information for the GAI model 150 to generate design updates. As such, Prompt Generation Module 335 may retrieve these metadata while not retrieving metadata with lower relevance. By retrieving the more relevant metadata for inclusion in prompts, Prompt Generation Module 335 generates focused prompts with less contextual information included for GAI model 150 to process. Once the metadata is retrieved, Prompt Generation Module 335 inserts the metadata design into a placeholder of the prompt template, such as “Base Design Metadata” placeholder in prompt template 910 of FIG. 9.

When generating a prompt requesting a base design update, Prompt Generation Module 335 may tailor the prompt depending on whether the generic base design is in Open Design Library 370 or Company Design Library 375. If the generic base design is in Open Design Library 370, the prompt may be tailored request a base design update based on common selections made by users across multiple organizations, while if the generic base design is in a Company Design Library 375, the prompt may be tailored to request a base design update based on common selections specific to the associated company. An example of a placeholder for tailoring the prompt is portrayed in the third placeholder in prompt template 910 of FIG. 9. This prompt tailoring prevents company-specific common selections from being applied to designs that are provided to users outside of the company, thus preserving proprietary information such as trade secrets.

Prompt Generation Module 335 also generates prompts for review of user selections. When U/I Module 310 receives an industrial design selection made by a user (for example, a selection made in user interfaces 800 of FIG. 8A-8D), Prompt Generation Module 335 selects a prompt template for requesting review of selections (e.g., prompt template 920 of FIG. 9). The prompt may be generated using the prompt template. Prompt Generation Module 335 may include data associated with the industrial design selection in a placeholder of the prompt template (e.g., the “industrial design selection data” placeholder in prompt template 920 of FIG. 9). The industrial design selection data included in the placeholder may include a description of the selection (e.g., an indication that the user selected a thermal circuit breaker in an option pack of a VFD). Prompt Generation Module 335 may insert other information into placeholders the prompt template, including the industry and the installation location for the industrial automation project.

A prompt generated by Prompt Generation Module 335 may further include a description of the industrial design selection (e.g., metadata associated with the industrial design selection). The description indicates details about the selection the user made (e.g., a selection of an option within an option pack of a generic base design). Additionally, the prompt may include a request for GAI model 150 to compare the industrial design selection against common selections among users of industrial design application 120. The GAI model 150 may have learned knowledge of common selections based from previous submissions of industrial automation projects provided to the GAI model 150 during training. The prompt may further request a brief narrative of a potential problem associated with the industrial design selection. FIG. 8E shows example brief narrative 891 generated by GAI model 150 in response to the prompt. The prompt may further include a request to generate suggestions based on common user selections for designs submitted in the same or similar industry or installation location. The industry and installation location may be included in the prompt since common selections among users of the industrial design application 120 may differ in various industries and install locations. FIG. 8E shows example alternate suggestion suggestions 893 generated by GAI model 150 in response to the prompt.

GAI Interface Module 345 interfaces with GAI model 150 to provide prompts to the GAI model 150 and receive responses from GAI model 150. Once Prompt Generation Module 335 generates a prompt as discussed above, GAI Interface Module 345 submits the prompts to GAI model 150. GAI Interface Module 345 also receives, from GAI model 150, responses to the submitted prompts. In the case of a base design update, GAI Interface Module 345 may receive updated metadata for an updated base design generated by GAI model 150. Upon receiving the updated metadata, GAI Interface Module 345 may perform initial validation for the updated metadata, including checking for corrupted data, checking syntax, and checking validity (e.g., checking that components included in the updated base design are valid components for the base design). Once GAI Interface Module 345 performs the initial validation, U/I Module 310 may provide the updated base design to an engineer (e.g., on admin device 112) for review, as described in step 413 of method 400.

User Notification Module 317 generates notifications regarding user selections to the users. User Notification Module 317 may include a brief narrative of any potential issues associated with a user's designs selection and the alternate selection suggestions generated by GAI model 150, in addition to selectable elements associated with the alternate selection suggestions. An example of such a notification is shown in FIG. 8E and discussed in greater detail below.

GAI Update Module 340 continually provides new data to GAI model 150 to update GAI model 150 over time. In some embodiments, GAI Update Module 340 provides GAI model 150 with finalized designs for industrial automation projects submitted by users. Finalized designs submitted by users are received by U/I Module 310, as discussed above. The finalized designs include detailed information about the configuration of the industrial automation project, including the industry, the installation location, and industrial design selections made by the user of the industrial design application. GAI model 150 updates learned information based on the finalized designs from the users of industrial design application 120. For example, GAI model 150 may learn, from processing finalized designs submitted from many users, that a certain selection has become more popular in a specific industry or country (e.g., engineers in Canada now select higher space factors for MCCs due to new regulations). As such, by continually providing the GAI model 150 with finalized designs submitted by users, GAI model 150 stays up to date with current preferences in various industries and locations.

GAI Update Module 340 may also provide GAI model 150 with other new industrial information in addition to the finalized designs submitted by users. For example, GAI Update Module 340 may provide GAI model 150 with new industrial product literature, new industry standard data, and new safety requirements data. GAI Update Module 340 thus continually fine-tunes GAI model 150 to learn current industry standards, such that GAI model 150 may accurately update the base designs and review industrial design selections.

In practice, U/I Module 310 receives an industrial design selection from a user configuring an industrial automation project. Prompt Generation Module 335 generates a prompt for GAI model 150 requesting a review of the industrial design selection and a request to respond with a brief narrative of a problem associated with the selection and one or more alternate selection suggestions. GAI Interface Module 345 submits the prompt to GAI model 150. GAI model 150 reviews the selection and responds with one or more alternate selection suggestions and a brief narrative of a potential problem associated with the industrial design selection. GAI Interface Module 345 receives the response from GAI model 150, including the brief narrative of a potential problem associated with the selection and one or more alternate selection suggestions. User Notification Module 317 generates a notification for the user, including the brief narrative, the one or more alternate selection suggestions, and a selectable element associated with each of the one or more alternate selection suggestions (as shown, for example, in FIG. 8E). U/I Module 310 provides the notification to the user via a user display on user device 110 (see FIG. 1). U/I Module 310 receives a user selection of an alternate selection suggestion and updates the design of the user's industrial automation project with the user's selection. Once the user has finished configuring the design, the user submits a finalized design of the industrial automation project (for example, by submitting a request for a quote). U/I Module 310 receives the user's submission. GAI Update Module 340 provides the finalized design to GAI model 150 for updating learned common selections made by users designing systems in similar industries and locations.

In another scenario, Design Update Module 313 may initiate an update of a generic base design in base design repository 140. The initiation of the update is based on a predetermined time-period elapsing since or an administrator's request for a base design update (received, for example, from admin device 112 of FIG. 1). Prompt Generation Module 335 retrieves metadata associated with the generic base design from base design repository 140 and generates a prompt requesting an updated base design based on common user selections for similar applications (e.g., similar industries and install locations), where the prompt includes the metadata. GAI Interface Module 345 submits the prompt to GAI model 150. GAI model 150 generates an updated base design based on common user selections in relevant industries and installation locations associated with the generic base design and responds to industrial design application 120 with updated metadata for an updated base design. GAI Interface Module 345 receives the updated metadata. U/I Module 310 provides the updated metadata of the updated base design to an administrator on admin device 112. The administrator reviews the updated base design. If the administrator indicates approval of the updated base design, U/I Module 310 receives the administrator's approval of the updated base design. Design Update Module 313 adds the updated base design to base design repository 140.

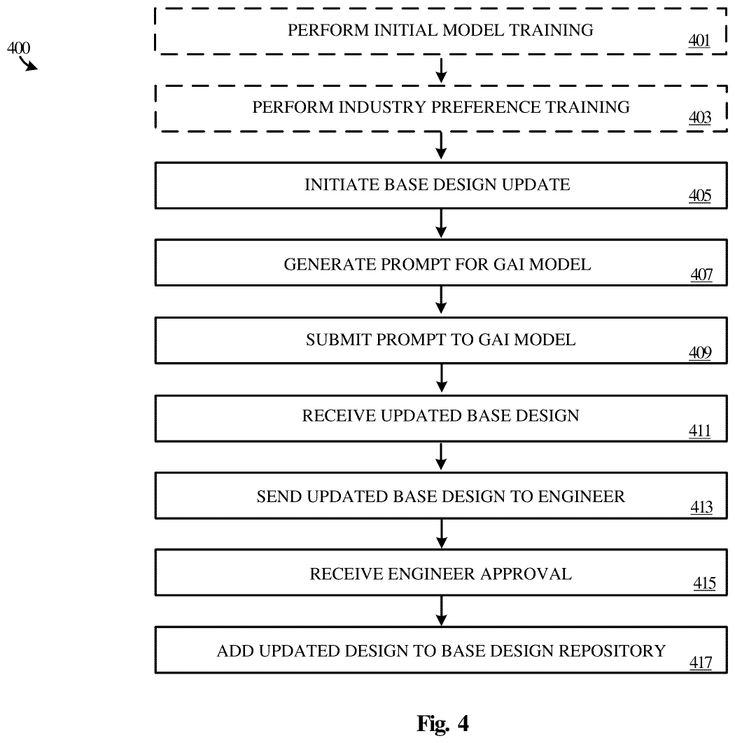

FIG. 4 illustrates computer-implemented method 400 for updating base designs performed according to some embodiments.

Step 401 of method 400 is performing initial GAI model training. Step 401 may be performed by GAI Update Module 340 of FIG. 3. In training GAI model 150, parameters of GAI model 150 are adjusted to encode learned information. Initial training of GAI model 150 is generally performed on a base model. A base model may be licensed and hosted by a third party, purchased, or acquired as an open-source model. The base model may have been pre-trained on a vast amount of data. In general, however, a base model is not specifically trained to perform industrial design functions. The initial training in step 401 fine-tunes GAI model 150 to perform industrial design tasks. The initial training in step 401 may be an unsupervised learning process, including providing the base model with industrial product literature, industry standard data, data about standard configurations for industrial units, safety requirements in various countries, and other data relevant to the industrial automation projects.

Step 403 of method 400 is performing industry preference training for GAI model 150. Step 403 may be performed by GAI Update Module 340 of FIG. 3. Industry preference training is performed by providing GAI model 150 with feedback, where the feedback includes user selections within industrial design application 120 and finalized industrial designs submitted by users in industrial design application 120. This feedback is provided to GAI model 150 continuously over time, such that GAI model 150 stays up to date with changing industry preferences in various industries.

Step 405 of method 400 is initiating a base design update for a generic base design, for example a generic base design stored in base design repository 140. Step 405 may be performed by Design Update Module 313 of FIG. 3. The base design update may be initiated for a generic base design when a pre-determined time-period has elapsed since the previous update of that generic base design. Alternatively, a generic base design may be updated when an administrator such as an engineer specifically requests for that base design to be updated.

Step 407 of method 400 is generating a prompt for GAI model 150. Step 407 may be performed by Prompt Generation Module 335 of FIG. 3. The prompt may be generated based on a prompt template, such as prompt template 910 of FIG. 9. The prompt may include the metadata of the generic base design (see, e.g., metadata 220 of FIG. 2) and a request to update the base design based on common industry preferences. The prompt may also differ depending on whether the generic base design to be updated is in open design library 370 of FIG. 3, or Company Design Library 375 of FIG. 3. As such the generating of the prompt in step 407 may include tailoring the prompt based on the library the generic base design is stored in. The generation of the prompt using the prompt template 910 is discussed further in FIG. 9 below.

Step 409 of method 400 is submitting the prompt (i.e., the prompt generated in step 407) to GAI model 150. Step 409 may be performed by GAI Interface Module 345 of FIG. 3.

Step 411 of method 400 is receiving an updated base design from GAI model 150. Step 411 may be performed by GAI Interface Module 345 of FIG. 3. The updated base design may include updated metadata for the generic base design generated by GAI model 150. GAI model 150 updates the metadata based on learned common selections among users designing projects in the same industry and installation location. GAI model 150 may continually learn the common selections over time. GAI model 150 is provided with finalized industrial designs submitted by users in industrial design application 120 to learn selections that are popular among many users. GAI model 150 may also be updated with other industrial information, such as external industrial designs, new industrial specifications, and new regulations and standards. As such, the updated base design generated by GAI model 150 is aligned with common industry standards and preferences learned by GAI model 150 from various sources. It is noted that GAI model 150 may generate updated base designs with new configurations that are popular among users from multiple organizations. As such, GAI model 150 may be trained to recognize if preferences are particular to a specific organization. If a preference is organization-specific, GAI model 150 will incorporate the preference into a company-specific base design while refraining from incorporating the preference into an open design. For example, if a preference is specific to Company 1, GAI model 150 will incorporate the generic base design into a generic base design in Company 1 Design library 375a of FIG. 3. A preference will not be incorporated into a generic base design in Open Design Library 370 unless the preference is applicable to users in multiple different organizations. GAI model 150 may be trained to recognize when a preference is either widespread or company specific. Several factors may play a role in this consideration, including the numbers of users in various organizations that have made selections aligning with the preference, the industries in which the selections are made, and the frequency of the selections. If a selection is widespread across multiple organizations, the preference may be incorporated by GAI model 150 into updated base designs for open design library 370 of FIG. 3.

Step 413 of method 400 is sending the updated base design to an administrator for review. Step 413 may be performed by U/I Module 310 of FIG. 3. The updated base design may be sent, for example, to admin device 112 of FIG. 1. The administrator may be an engineer who reviews the updated base design to ensure that the updated base design is in accordance with industry standards and applicable laws and regulations. The administrator may be presented with the option (e.g., via selectable elements) to either approve the updated base design for inclusion in base design repository 140 or reject the base design.

Step 415 of method 400 is receiving approval for the base designs. Step 415 may be performed by U/I Module 310 of FIG. 3. Industrial design application 120 receives the administrator approval once the administrator approves of the base design provided to the administrator in Step 413.

Step 417 of method 400 is updating the generic base design in base design repository 140. Step 417 may be performed by Design Update Module 313 of FIG. 3. Industrial design application 120 updates the generic base design if the administrator approval is received in Step 415. Updating the generic base design may include adding the updated base design to base design repository 140. In some embodiments, the original generic base design provided to GAI model 150 may be kept in base design repository 140 until an administrator reviews it and determines to either remove it or keep it. Accordingly, once the updated base design is added to base design repository 140, industrial design application 120 may prompt the administrator to review the original base design.

It is noted that if the administrator rejects the updated base design in Step 413, industrial design application 120 receives the rejection and does not add the updated base design to base design repository 140, according to some embodiments. Instead, industrial design application 120 may provide an indication of the rejection to GAI model 150 as feedback.

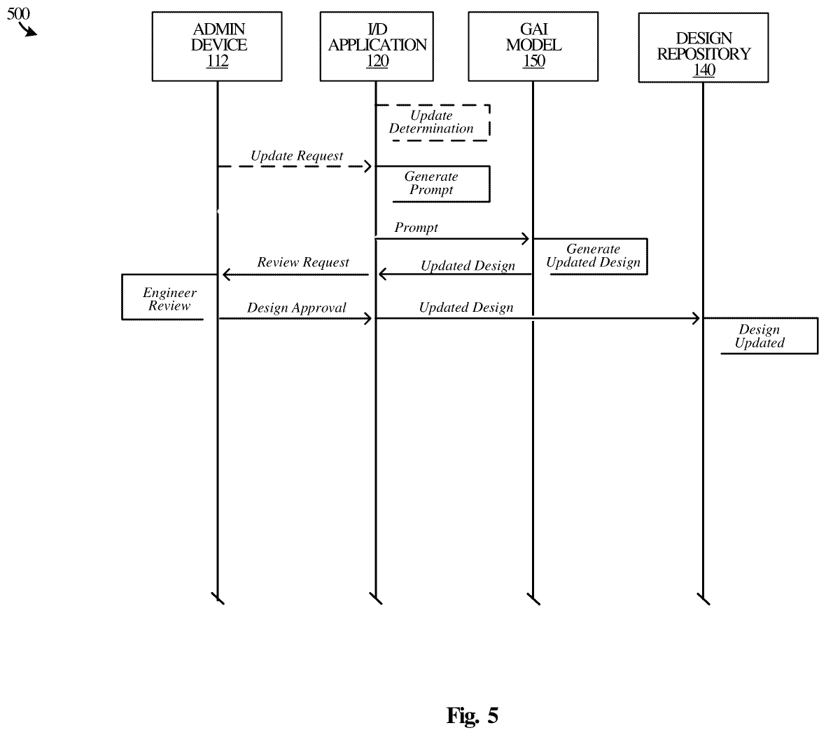

FIG. 5 illustrates operational scenario 500 performed according to some embodiments. Operational scenario 500 includes the user device 110, the industrial design application 120, the base design repository 140, and the GAI model 150.

Operational scenario 500 may begin in two different ways, as indicated by the dotted lines in FIG. 5. In one scenario, an administrator on admin device 112 may submit an update request to industrial design application 120 (e.g., via U/I Module 310 of FIG. 3). The update request may be a request to update a specific generic base design in base design repository 140. In another scenario, industrial design application 120 makes an update determination, which is a determination to update a specific generic base design in base design repository 140. The update determination may be made, for example, by determining that a pre-determined time period has elapsed since the last update. The update determination may be made by the Design Update Module 313 of FIG. 3. Once either the request is received or the determination is made, industrial design application 120 (e.g., Prompt Generation Module 335 of FIG. 3) generates a prompt for GAI model 150. The prompt may include some or all of the metadata for the generic base design and a request to update the generic base design based on common configurations. The prompt may be generated based on a prompt template, such as prompt template 910 of FIG. 9. Industrial design application 120 (e.g., GAI Interface Module 345 of FIG. 3) submits the prompt to GAI model 150. Upon receiving the prompt, GAI model 150 generates a response, the response including updated metadata for the generic base design. GAI model 150 provides the updated metadata to industrial design application 120 (e.g., via GAI Interface Module 345 of FIG. 3). Industrial design application 120 then sends the updated metadata of the generic base design to admin device 112 for review (e.g., via U/I Module 310 of FIG. 3). An administrator on admin device 112 reviews the updated base design. The administrator (such as an engineer) may check the updated base design for quality, conformity with standards and regulations, and for any potential issues related to adding the updated base design to base design repository 140. If the administrator approves the updated base design, the administrator submits an approval to industrial design application 120 (e.g., via U/I Module 310 of FIG. 3). Industrial design application 120 (e.g., Design Update Module 313 of FIG. 3) adds the updated base design to base design repository 140.

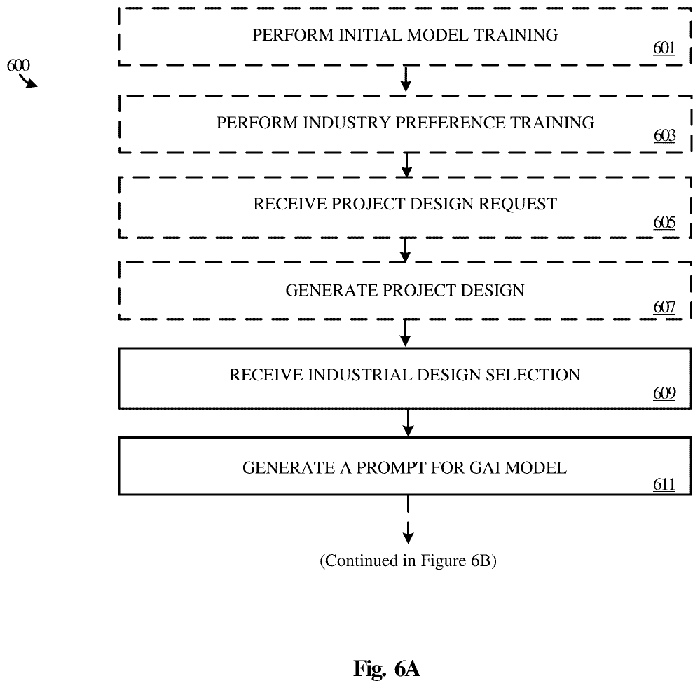

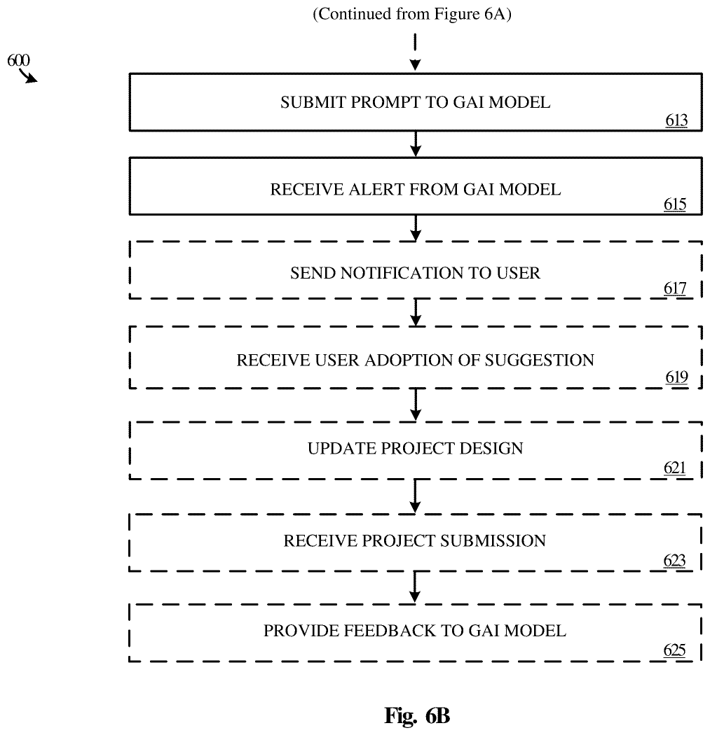

FIGS. 6A and 6B illustrate computer-implemented method 600 performed according to some embodiments. In some embodiments, method 600 may utilize the same GAI model (i.e., GAI model 150) as method 400. The training of the GAI model 150 in step 601 and step 603 may be the same as set forth in step 401 and step 403 of method 400, discussed above. It is noted that in other embodiments, separate GAI models may be utilized in the execution of methods 400 and 600.

Step 605 of method 600 is receiving a request from a user for a design of an industrial automation project. Step 605 may be performed by U/I Module 310 of FIG. 3. The user creates the request on a user interface of a user device such as user device 110a in FIG. 1. The request may include parameters of an industrial automation project the user wishes to design. In the example of an MCC, the request includes a motor-load list, as well as the industry and the installation location for the MCC.

Step 607 is generating a design of the industrial automation project in response to the request from the user. Step 607 may be performed by U/I Module 310 of FIG. 3. The generation of a project design in Step 607 may utilize the base design repository 140 and GAI model 150 to provide a customized design for the user, as discussed in further detail in related applications incorporated by reference above. The design of the industrial automation project is generated to meet the parameters of the user's request. For example, it may include motor controllers corresponding to every motor load in the motor load list of the request. Once the design of the industrial automation project is generated, a user on user device 110 may view the industrial automation project via the user interface of industrial design application 120.

Step 609 of method 600 is receiving an industrial design selection from a user. Step 609 may be performed by U/I Module 310 of FIG. 3. In step 609, industrial design application 120 receives a user selection for a configuration within the industrial automation project generated for the user. While the generated industrial automation project is preferably close as possible to complying with the user's request, it is anticipated that users will often make alterations to the generated design. As such, the user may reconfigure the design of the industrial automation project. For example, the user may swap out an industrial unit (such as a motor controller) for a different model, or may reconfigure selectable options within the industrial unit, as shown, for example, in FIGS. 8C and 8D. It is noted that multiple design selections may be made by the user in the design of the industrial automation project. The steps of method 600 may be carried out each time an industrial design selection is received.

Step 611 is generating a prompt for GAI model 150. Step 611 may be performed by Prompt Generation Module 335 of FIG. 3. The prompt may be generated in response to receiving the user selection of step 609. The prompt may include the industrial design selection and other contextual information, as shown, for example in prompt template 920 of FIG. 9. The prompt further includes a request for GAI model 150 to determine if the user design selection is a common selection based on finalized industrial design submissions from the users of industrial design application 120. The prompt may further include a request to generate a brief narrative of a potential problem associated with the selection, and one or more alternate configuration options for the user if the user design selection is an irregular selection.

Step 613 is submitting the prompt (i.e., the prompt generated in step 611) to GAI model 150. Step 613 may be performed by the GAI Interface Module 345 of FIG. 3.

Step 615 is receiving a brief narrative and one or more alternate selection suggestions from GAI model 150. Step 615 may be performed by GAI Interface Module 345 of FIG. 3. The alert and suggestion may be generated by the GAI model 150 based on learned common industrial design selections. As set forth in Step 411 of the method 400 above, GAI model 150 may continuously learn common selections over time. Based on the learned common industrial selections, GAI model 150 may have determined that the design selection made by the user is an irregular selection.

The brief narrative generated by GAI model 150 in step 615 explains any issues regarding the selection to the user, including if the selection would not be compatible with the rest of the design, or if it violates a specification or regulation. An example brief narrative 891 is shown FIG. 8E. GAI model 150 may also generate one or more alternate selection suggestions based on learned common configurations, as shown, for example in alternate selection suggestions 893 of FIG. 8E. GAI model 150 may also send a confirmation of the selection to industrial design application 120 if the selection is in accordance with common industrial design selections. If industrial design application 120 receives confirmation from GAI model 150, no user notification is generated, according to some embodiments. However, if GAI model 150 returns an alert and suggestions to industrial design application 120, a notification is sent to the user as set forth below.

Step 617 is sending a notification to the user. Step 617 may be performed by U/I Module 310 of FIG. 3. The notification may include the alert and the suggestions generated by GAI model 150 and may further include selectable elements for users to adopt the suggestion. An example notification is shown in FIG. 8E.

Step 619 is receiving the user's adoption of the selection. Step 619 may be performed by the U/I Module 310 of FIG. 3. For example, in FIG. 8E the user has selected one of the suggestions from the GAI model 150. Once the user submits the selection (for example, by clicking “Apply” in the user interface 800 of FIG. 8E), the user's adoption of the selection is received by industrial design application 120. Step 621 is updating the project design to include the suggestion of GAI model 150 adopted by the user. It is noted that the user may also have elected to keep the initial selection. In such case, the design of the project is not updated, and feedback is provided to GAI model 150 indicating that the user did not adopt the GAI model suggestion. This allows GAI model 150 to learn certain user-specific preferences, so that GAI model 150 will refrain from providing the same suggestion to a user who, in the past, has usually rejected similar suggestions.

Step 623 of method 600 is receiving the user's submission of a finalized design of the industrial automation project. Step 623 may be performed by the U/I Module 310 of FIG. 3. Once the user has made any desired selections and arrived at the final design, the user may submit the finalized design of the industrial automation project. The submission may include, for example, a request for a quote.

Step 625 of method 600 is providing the finalized design to GAI model 150 as feedback for updating the learned common industrial design selections of GAI model 150. Step 625 may be performed by the GAI Interface Module 345 of FIG. 3. Since designs may be submitted by many users across various industries, the submission of this feedback allows GAI model 150 to stay updated with industry trends.

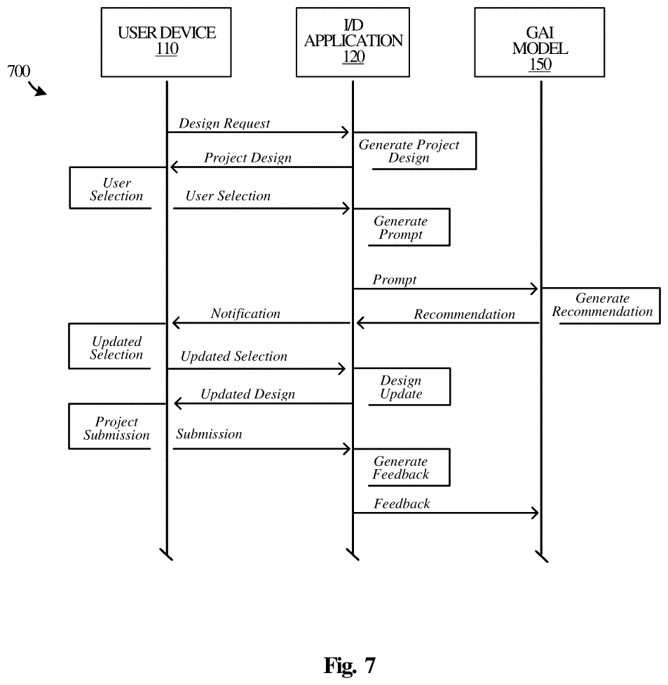

FIG. 7 shows operational scenario 700 according to some embodiments. Operational scenario 700 includes the user device 110, industrial design application 120, and GAI model 150.

Operational scenario 700 begins with a user submission of a design request, from user device 110 (e.g., via U/I Module 310 of FIG. 3). In response, industrial design application 120 generates a design to meet the parameters set forth in the request. For example, in the context of an MCC the generated design may include a series of motor controllers to meet the parameters set forth in a motor-load list. The user on user device 110 may make one or more user selections reconfiguring the design of the project generated by industrial design application 120. Each time the user makes a selection, the selection is received by the industrial design application 120 (e.g., via U/I Module 310 of FIG. 3). In response to receiving the selection, Industrial design application 120 (e.g., Prompt Generation Module 335 of FIG. 3), generates a prompt for GAI model 150. The prompt may include the industrial design selection, a request to review the selection, and other relevant contextual information as shown in prompt template 920 of FIG. 9. Once the prompt is generated, the industrial design application 120 (e.g., the GAI Interface Module 345 of FIG. 3) submits the prompt to GAI model 150. GAI model 150 may then generate a recommendation, which may include an alert and a suggestion for the user regarding the selection. GAI model 150 returns the recommendation to the industrial design application (e.g., via GAI Interface module 345 of FIG. 3). The industrial design application 120 (e.g., the User Notification Module 317 of FIG. 3) generates a notification including the recommendation from GAI model 150. The notification is provided to the user (e.g., via the U/I Module 310 of FIG. 3). An example notification is shown in user interface 800 of FIG. 8E. The user may adopt and submit one of the suggestions generated by GAI model 150. The adoption of the selection is submitted to industrial design application 120 (e.g., via U/I Module 310 of FIG. 3), and the project design is updated. Once the user is satisfied with the design of the project, the user may submit the finalized design of the industrial automation project. The submission may include, for example, a request for a quote. In response, industrial design application 120 generates feedback for GAI model 150, where the feedback includes the finalized design of the industrial automation project. The feedback is provided to GAI model 150 (e.g., via GAI Interface Module 345 of FIG. 3) for updating learned common industrial design selections.

FIG. 8A illustrates a screen of user interface 800 viewed by users accessing industrial design application 120 on user device 110. User interface 800 shows a display in which a user may create a request for a design of an industrial automation project (in this case, an MCC). In Product Selection field 805, the user selects a desired product. In this case, a user has elected to request a design for a “CENTERLINE IEC Motor Control Center.” In Project Details field 810, the user enters parameters for the industrial automation project to be designed. Project Details field 810 includes a “Project Name,” a “Configuration Name,” a “Sold to Location,” an “Installation Location,” and the “Industry.” The illustrated project details 810 are exemplary only.

In addition to entering data in Project Details field 810, the user creates a motor-load list 815, in this example. The motor-load list includes the controllers to be included in the MCC, where each controller may be utilized to drive a certain component in the industrial automation device (e.g., pumps, belts, and mixers) in the industrial automation project. For each motor load, the user indicates the name of the MCC, the Load Name, the type of controller, the rating for the controller, the Rating Unit, and the Full Load Amps (where some fields may not be included depending on the component requested). Clickable fields 820 allow a user to add a new load (i.e., motor controller) to the list, copy selected loads, or delete selected loads. When a user is satisfied with the parameters, the user may click the “View Selected Configuration” button 825. Clicking button 825 is the request for a design of an industrial automation project, as discussed, for example, in step 605 of method 600.

FIG. 8B illustrates another screen of user interface 800 displayed to users accessing industrial design application (e.g., industrial design application 120). User interface 800 of FIG. 8B shows a display of an initial design for an industrial automation project from the industrial design application (e.g., industrial design application 120 in FIG. 1). The initial design may be generated based on the parameters input by the user in user interface 800 of FIG. 8A. The initial design may include user-specific customizations, as discussed in greater detail in related applications incorporated by reference above. Field 830 displays basic information about the generated design, including the name of the design, the name of the configuration, the Line Voltage, the Control Voltage, and an estimated price for the configuration. Field 835 displays MCCs included in the design. In this example, the user has requested one MCC in the design; however, users may be able to request a design including multiple MCCs. The Design Layout field 840 shows a broad view of the layout of the design of the industrial automation project. The layout in Design Layout Field 840 shows a graphical depiction of the layout of the industrial automation project design. For example, the layout may include a motor controller for each motor controller requested in motor-load list 815 of FIG. 8A.

The view in FIG. 8B shows high-level information about each base design, where each base design represents an industrial unit (industrial unit 210) such as a motor controller. For example, the bottom unit in the second column of the MCC design in FIG. 8B is an SMC (Smart Motor Controller). “2Q” indicates the location of the SMC in the generated layout (i.e., position Q of the second column.” “Unit 2” indicates the name provided by the user in FIG. 8A. The power and amperage of the SMC is also displayed. A user may select any industrial unit in the design layout field 840 to view further details about the configuration of the selected industrial unit, as discussed in relation to FIG. 8C below. The user may click Generate Field 845 to request alternate graphical representations of the MCC (such as a schematic electrical view or a top-down view).

FIG. 8C illustrates another screen of user interface 800 that is displayed when the user selects an industrial unit from the layout in FIG. 8B. FIG. 8C shows user interface 800 that is displayed when the user selects a component from the layout in FIG. 8B. In the example of FIG. 8C, the user has selected “Unit 2” (the SMC). The selection of the component by the user causes Unit Window 870 to be overlayed in user interface 800. Configuration list 865 shows details of how the SMC is configured. Configuration list 865 represents multiple configurable attribute selections in the customized base design generated by GAI model 150. For example, the customized base design includes a Mounting Type of “Withdrawable,” which may be based on a learned user-preference of GAI model 150 that a specific user generally prefers withdrawable mounting for SMCs. The user has the option of swapping the design of the SMC for alternative design 860, which may be additional customized base designs generated by GAI model 150. Alternatively, alternative designs 860 may be generic base designs selected from the base design repository (such as base design repository 140 in FIG. 1). A user also has the option of editing the details of the design of the unit (the SMC) provided by clicking the “Edit Unit Details” button 855. Any user selection in user interface 800 of FIG. 8C may trigger a generation of a prompt for the GAI model 150 to review the industrial design selection, as discussed in the method 600 above.

FIG. 8D illustrates another screen of user interface 800 that is displayed after a user has selected Edit Unit Details Button 855 of FIG. 8D. FIG. 8D shows user interface 800 after a user has selected the “Edit Unit Details” button 855 of FIG. 8C. Specifically, upon the user request to edit the unit details, the Unit Configuration Window 875 appears on screen. Unit Configuration Window 875 includes option packs 880 of the unit the user requested to edit. Each option pack 680 includes selectable options 885 which are selectable by the user to configure the unit. The user may edit the configuration by selecting one of option packs 880. In this case, the user has selected “Operator Station.” The user may then select one of selectable options 885. This allows the user to deviate from the customized base design provided by GAI model 150. Option packs 880 may be option packs 220j of FIG. 2.

As an example, a generic base design (e.g., in base design repository 140 of FIG. 1) may include an operator station with a 3-Position Switch, three indicator lights (G, Red, and Amber) and a HIM (see the top-left selectable option of selectable options 885). Such a generic base design may be selected for example, in step 407 of method 400. However, GAI model 150 may have learned based on past usage that the user requesting the design usually wants only a HIM (which may be, for example, for cost saving purposes). As such, the customized base design generated by GAI model 150 may include “With HIM” as an operator station (the third option on the right). Such a customized base design may be generated as discussed in greater detail in related applications incorporated by reference above. In the present design, the user does not want an operator station for a particular SMC; thus, the user has deviated from the customized base design by selecting “Without Operator Station” on the top right. The industrial design selection “Without Operator Station” is received by industrial design application 120 as discussed, for example, in step 609 of method 600. A prompt is generated requesting GAI model 150 to review the selection. GAI model 150 may respond with suggestions for the user, which are provided to the user in a notification, as discussed in FIG. 8E below.

FIG. 8E illustrates another screen of user interface 800 viewed by users accessing industrial design application 120 on user device 110. FIG. 8E illustrates an example of a model-generated notification 890 sent to the user. Notification 890 may have been generated based on a determination by GAI model 150 that the selection was an irregular selection. The notification includes brief narrative 891 generated by the GAI model briefly setting forth a potential problem associated with the user's selection. Notification 890 also includes alternate selection suggestions 893, generated by GAI model 150 based on learned common configurations and user-specific preferences. Industrial design application 120 generates notification 890 to include brief narrative 891 alternate selection suggestions 893 received from GAI model 150, selectable elements 897 associated with the alternate selection suggestions, and submission field 895 for the user to submit the selected suggestion.

FIG. 9 illustrates prompt templates 910, 920 according to some embodiments. Prompt templates 910, 920 are files stored in industrial design application 120. Prompt templates 910 may include a combination of text and placeholders, where the placeholders are replaced with the relevant data during prompt generation as discussed below. Prompt templates 910, 920 may be utilized, for example, by Prompt Generation Module 335 of FIG. 3 to generate prompts for GAI model 150.

Prompt template 910 may be used for requesting updates of generic base designs as set forth in method 400 and operational scenario 500 discussed above. Prompt template 910 includes multiple placeholders that are filled in with appropriate data to generate the prompt. The placeholders in prompt template 910 include <base design data> and <industries>. During prompt generation, the placeholder <base design data> is replaced with information about the generic base design, such as the generic base design selected from base design repository 140 of FIG. 1. This may include, for example, some or all metadata 220 of FIG. 2. The <industries> placeholder is filled in with the applicable industries for the generic base design. This industry may be provided as contextual information in the prompt since design preferences may vary among various industries.

The request to update the base design in prompt template 910 includes the placeholder: < “Based on common preferences specific to [Company X]” or “Based on common user preferences across multiple organizations.”> This generated prompt will select the text string from this placeholder depending on which design library from base design repository 140 the generic base design is stored in. For example, if the generic base design is in Company 1 Design Library 375a, the placeholder will be filled in with: “Based on common preferences specific to Company 1.” Alternatively, if the generic base design is stored in open design library 370, the placeholder will be filled in with: “Based on common user preferences across multiple organizations.” This tailoring of the prompt allows GAI model 150 to tailor generic base designs for specific companies without using company specific design information for users outside of the organization. If the generic base design is in Open Design Library 370, the prompt indicates to GAI model 150 that the generic base design is to be updated based on common user preferences across multiple organizations. As such, generic base designs in Open Design Library 370 will not be updated based on preferences specific to an organization. This arrangement facilitates the protection of company specific design information and intellectual property.

Prompt template 920 may be used for reviewing user design selections, as set forth in method 600 and operational scenario 700 described above. During prompt generation, the industrial design selection made by the user is inserted into the <industrial design selection data> placeholder. The <industry> placeholder is filled in with the industry for the user's industrial automation project, and the <Installation Location> location placeholder is filled in with the installation location for the industrial automation project. This contextual information allows GAI model 150 to take the industry and installation location into account to determine if the user's selection was an irregular selection (since different areas and industries have differing industrial standards, regulations, and preferences). A user identification associated with the user is inserted into the <user identification> placeholder. This allows GAI model 150 to tailor the review of selections for a specific user. For example, a user may have rejected a specific suggestion from GAI model 150 several times in the past. GAI model 150 may have learned this preference of the user and confirm the user's selection even if the selection is an irregular selection.

Prompt template 920 includes a request for GAI model 150 to respond with a “Y” if the industrial design selection is a common selection. Thus, if industrial design application 120 submits a prompt for a review of an industrial design selection, GAI model 150 will respond with a “Y” if the industrial design selection is a common selection among users of industrial design application 120. Industrial design application 120, upon receiving a “Y,” takes no further action according to some embodiments.

Once the prompt is generated based on the prompt template and the prompt is provided to GAI model 150, GAI model 150 uses the information in the prompt as contextual information to update the generic base design or review the industrial design selection. It is noted that prompt templates 910, 920 are representative. Other embodiments may include different request language, and may include additional placeholders, or fewer placeholders.

FIG. 10 illustrates computing device 1001 that is representative of any system or collection of systems in which the various processes, programs, services, and scenarios disclosed herein may be implemented. Examples of computing device 1001 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 1001 may be implemented as a single apparatus, system, or device or may be implemented in a distributed manner as multiple apparatuses, systems, or devices. Computing device 1001 includes, but is not limited to, processing system 1002, storage system 1003, software 1005, communication interface system 1007, and user interface system 1009. Processing system 1002 is operatively coupled with storage system 1003, communication interface system 1007, and user interface system 1009.

Processing system 1002 loads and executes software 1005 from storage system 1003. Software 1005 includes and implements industrial design application 120, which is (are) representative of the application service processes discussed with respect to the preceding figures, such as method 400 of FIG. 4 and method 600 of FIGS. 6A and 6B. When executed by processing system 1002, software 1005 directs processing system 1002 to operate as described herein for at least the various processes, operational scenarios, and sequences discussed in the foregoing implementations. Computing device 1001 may optionally include additional devices, features, or functionality not discussed for purposes of brevity.

Referring still to FIG. 10, processing system 1002 may comprise a microprocessor and other circuitry that retrieves and executes software 1005 from storage system 1003. Processing system 1002 may be implemented within a single processing device but may also be distributed across multiple processing devices or sub-systems that cooperate in executing program instructions. Examples of processing system 1002 include general purpose central processing units, graphical processing units, application specific processors, and logic devices, as well as any other type of processing device, combinations, or variations thereof.

Storage system 1003 may comprise any computer-readable storage media device readable by processing system 1002 and capable of storing the software 1005. Storage system 1003 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated or transitory signal.

In addition to computer readable storage media, in some implementations storage system 1003 may also include computer readable communication media over which at least some of software 1005 may be communicated internally or externally. Storage system 1003 may be implemented as a single storage device but may also be implemented across multiple storage devices or sub-systems co-located or distributed relative to each other. Storage system 1003 may comprise additional elements, such as a controller, capable of communicating with processing system 1002 or possibly other systems.

Software 1005 (including industrial design application 120) may be implemented in software instructions and among other functions may, when executed by processing system 1002, direct processing system 1002 to operate as described with respect to the various operational scenarios, sequences, and processes illustrated herein. For example, software 1005 may include program instructions for implementing an application service process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1005 may include additional processes, programs, or components, such as operating system software, virtualization software, or other application software. The software 1005 may also comprise firmware or some other form of machine-readable processing instructions executable by the processing system 1002.

In general, software 1005 may, when loaded into the processing system 1002 and executed, transform a suitable apparatus, system, or device (of which the computing device 1001 is representative) overall from a general-purpose computing system into a special-purpose computing system customized to support an application service in an optimized manner. Indeed, encoding software 1005 on the storage system 1003 may transform the physical structure of storage system 1003. The specific transformation of the physical structure may depend on various factors in different implementations of this description. Examples of such factors may include, but are not limited to, the technology used to implement the storage media of storage system 1003 and whether the computer-storage media are characterized as primary or secondary storage, as well as other factors.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

What is claimed is:

1. A computer-implemented method for providing industrial design suggestions, the method comprising:
receiving, via a user interface of an industrial design application, an industrial design selection from a user of a plurality of users of the industrial design application, wherein the industrial design selection comprises a selection of a configuration option in a design of an industrial automation project;
generating a prompt to elicit a reply from a General Artificial Intelligence (GAI) model trained on data including previous industrial design submissions from the plurality of users, the prompt comprising:
a description of the industrial design selection and the design, and
a request for the GAI model to compare the design with the industrial design selection against common selections learned from the previous industrial design submissions to identify uncommon selections;
submitting the prompt to the GAI model;
receiving, in response to the prompt, the reply comprising one or more alternate selection suggestions for the configuration option, wherein the one or more alternate selection suggestions are representative of previous selections made in the previous industrial design submissions from the plurality of users of the industrial design application; and
providing a notification to the user via the user interface, the notification comprising the one or more alternate selection suggestions.

2. The computer-implemented method of claim 1, wherein the notification further comprises one or more selectable elements corresponding to the one or more alternate selection suggestions, the method further comprising:
receiving, from the user in response to the notification, a user selection of a first of the selectable elements indicating an adoption of a first of the alternate selection suggestions; and
updating the design of the industrial automation project with the first of the alternate selection suggestions.

3. The computer-implemented method of claim 1, the method further comprising:
providing the GAI model with static data during initial training, the static data comprising one or more of: industrial product literature, industry standard data, and safety requirements data.

4. The computer-implemented method of claim 1, further comprising:
receiving from a user, via the user interface, a request from a user for a design of the industrial automation project; and
providing to the user, via the user interface in response to the request, an initial design for the industrial automation project, wherein the industrial design selection from the user comprises a modification of the initial design provided to the user.

5. The computer-implemented method of claim 4, wherein the method further comprises:
receiving from the user, via the user interface, a submission of a finalized design of the industrial automation project; and
providing the finalized design to the GAI model for updating learned common selections among users of the industrial design application.

6. The computer-implemented method of claim 1, wherein the prompt further requests a brief narrative of a potential problem associated with the industrial design selection, and wherein the notification sent to the user further comprises the brief narrative.

7. The computer-implemented method of claim 1, wherein the prompt for the GAI model further comprises an industry and an install location for the industrial automation project, and a request to generate suggestions based on common user selections for designs submitted in the industry and the install location.

8. A system for providing industrial design suggestions, the system comprising:
one or more processors; and
one or more memories operably coupled to the one or more processors and having stored thereon software instructions that, upon execution by the one or more processors, cause the one or more processors to:
receive, via a user interface of an industrial design application, an industrial design selection from a user of a plurality of users of the industrial design application, wherein the industrial design selection comprises a selection of a configuration option in a design of an industrial automation project;
generate a prompt to elicit a reply from a General Artificial Intelligence (GAI) model trained on data including previous industrial design submissions from the plurality of users, the prompt comprising:
a description of the industrial design selection and the design, and
a request for the GAI model to compare the design with the industrial design selection against common selections learned from the previous industrial design submissions to identify uncommon selections;
submit the prompt to the GAI model;
receive, in response to the prompt, the reply comprising one or more alternate selection suggestions for the configuration option, wherein the one or more alternate selection suggestions are representative of previous selections made in the previous industrial design submissions from the plurality of users of the industrial design application; and
provide a notification to the user via the user interface, the notification comprising the one or more alternate selection suggestions.

9. The system of claim 8, wherein the notification further comprises one or more selectable elements corresponding to the one or more alternate selection suggestions, and wherein the software instructions comprise further instructions that, upon execution by the one or more processors, cause the one or more processors to:
receive, from the user in response to the notification, a user selection of a first of the selectable elements indicating an adoption of a first of the alternate selection suggestions; and
update the design of the industrial automation project with the first of the alternate selection suggestions.

10. The system of claim 9, wherein the software instructions comprise further instructions that, upon execution by the one or more processors, cause the one or more processors to:
provide the GAI model with static data during initial training, the static data comprising one or more of: industrial product literature, industry standard data, and safety requirements data.

11. The system of claim 8, wherein the software instructions comprise further instructions that, upon execution by the one or more processors, cause the one or more processors to:
receive from a user, via the user interface, a request from a user for a design of the industrial automation project; and
provide to the user, via the user interface in response to the request, an initial design for the industrial automation project, wherein the industrial design selection from the user comprises a modification of the initial design provided to the user.

12. The system of claim 8, wherein the user is one of a plurality of users of the industrial design application, and wherein the software instructions comprise further instructions that, upon execution by the one or more processors, cause the one or more processors to:
receive from the user, via the user interface, a submission of a finalized design of the industrial automation project; and
provide the finalized design to the GAI model for updating learned common selections among users of the industrial design application.

13. The system of claim 8, wherein the prompt further requests a brief narrative of a potential problem associated with the industrial design selection, and wherein the notification sent to the user further comprises the brief narrative.

14. The system of claim 8, wherein the prompt for the GAI model further comprises an industry and an install location for the industrial automation project, and a request to generate suggestions based on common user selections for designs submitted in the industry and the install location.

15. A computer-readable storage media device having program instructions stored thereon for providing industrial design suggestions, wherein the program instructions, upon execution by one or more processors, cause the one or more processors to:
receive, via a user interface of an industrial design application, an industrial design selection from a user of a plurality of users of the industrial design application, wherein the industrial design selection comprises a selection of a configuration option in a design of an industrial automation project;
generate a prompt to elicit a reply from a General Artificial Intelligence (GAI) model trained on data including previous industrial design submissions from the plurality of users, the prompt comprising:
a description of the industrial design selection and the design, and
a request for the GAI model to compare the design with the industrial design selection against common selections learned from the previous industrial design submissions to identify uncommon selections;
submit the prompt to the GAI model;
receive, in response to the prompt, the reply comprising one or more alternate selection suggestions for the configuration option, wherein the one or more alternate selection suggestions are representative of previous selections made in the previous industrial design submissions from the plurality of users of the industrial design application; and
provide a notification to the user via the user interface, the notification comprising the one or more alternate selection suggestions.

16. The computer-readable storage media device of claim 15, wherein the notification further comprises one or more selectable elements corresponding to the one or more alternate selection suggestions, and wherein the program instructions comprise further program instructions that, upon execution by the one or more processors, cause the one or more processors to:
receive, from the user in response to the notification, a user selection of a first of the selectable elements indicating an adoption of a first of the alternate selection suggestions; and
update the design of the industrial automation project with the first of the alternate selection suggestions.

17. The computer-readable storage media device of claim 16, wherein the program instructions comprise further program instructions that, upon execution by the one or more processors, cause the one or more processors to:
provide the GAI model with static data during initial training, the static data comprising one or more of: industrial product literature, industry standard data, and safety requirements data.

18. The computer-readable storage media device of claim 15, wherein the program instructions comprise further program instructions that, upon execution by the one or more processors, cause the one or more processors to:
receive from a user, via the user interface, a request from a user for a design of the industrial automation project; and
provide to the user, via the user interface in response to the request, an initial design for the industrial automation project, wherein the industrial design selection from the user comprises a modification of the initial design provided to the user.

19. The computer-readable storage media device of claim 15, wherein the user is one of a plurality of users of the industrial design application, and wherein the program instructions comprise further program instructions that, upon execution by the one or more processors, cause the one or more processors to:
receive from the user, via the user interface, a submission of a finalized design of the industrial automation project; and
provide the finalized design to the GAI model for updating learned common selections among users of the industrial design application.

20. The computer-readable storage media device of claim 15, wherein the prompt further requests a brief narrative of a potential problem associated with the industrial design selection, and wherein the notification sent to the user further comprises the brief narrative.
